(19) United States
(12) Patent Application Publication
(10) Pub. No.: US 2026/0051931 A1
(43) Pub. Date: Feb. 19, 2026

(54) SOUNDING REFERENCE SIGNAL RESOURCE REUSE OR COLLISION HANDLING AND ANTENNA SELECTION REPORTING

(71) Applicant: QUALCOMM Incorporated, San Diego, CA (US)

(72) Inventors: Hyojin LEE, San Diego, CA (US); Yu ZHANG, San Diego, CA (US); Jing SUN, San Diego, CA (US); Jing JIANG, San Diego, CA (US)

(21) Appl. No.: 18/807,729

(22) Filed: Aug. 16, 2024

(51) Int. Cl. H04B 7/06; H04L 5/00

(52) U.S. Cl. CPC H04B 7/061; H04L 5/0051

(57) ABSTRACT

Methods, systems, and devices for wireless communications are described. In some examples, a user equipment (UE) uses a same sounding reference signal (SRS) resource for multiple usages, such as for an antenna selection operation and a codebook operation to facilitate efficient SRS utilization. In some examples, rather than reusing the same SRS resources, different SRS resource sets are configured for different usages, respectively, and the different SRS resources may partially or completely overlap (e.g., collide) in a time and/or a frequency, with SRS collisions handled based on different priorities associated with the different SRS resource sets. Based on one or more transmitted SRSs, the UE receives from a network entity an indication of candidate antenna selection results or SRS measurements, which the UE to uses to make and report a final antenna selection.

### FIELD OF TECHNOLOGY

The following relates to wireless communications, including sounding reference signal resource reuse or collision handling and antenna selection reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications, a UE may be configured with one or more sounding reference signal (SRS) resources set in which to communicate an SRS signal to a network entity.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, at the UE, a first sounding reference signal (SRS) configuration that indicates a first SRS resource set associated with an antenna selection usage, receiving, at the UE, a second SRS configuration that indicates a second SRS resource set associated with a second usage, where at least one SRS resource is included in both the first SRS resource set and the second SRS resource set, and transmitting, by the UE, a plurality of SRSs that includes a first set of SRSs associated with the antenna selection usage and a second set of SRSs associated with the second usage, where at least one SRS of the plurality of SRSs is transmitted via the at least one resource and is included in both the first set of SRSs and the second set of SRSs.

A UE for wireless communications is described. The UE may include one or more memories storing processor executable code, a transceiver, and one or more processors coupled with the one or more memories. The one or more processors may individually or collectively be operable to execute the code to cause the UE to receive, at the UE via the transceiver, a first SRS configuration that indicates a first SRS resource set associated with an antenna selection usage, receive, at the UE via the transceiver, a second SRS configuration that indicates a second SRS resource set associated with a second usage, where at least one SRS resource is included in both the first SRS resource set and the second SRS resource set, and transmit, by the UE via the transceiver, a plurality of SRSs that includes a first set of SRSs associated with the antenna selection usage and a second set of SRSs associated with the second usage, where at least one SRS of the plurality of SRSs is transmitted via the at least one resource and is included in both the first set of SRSs and the second set of SRSs.

Another UE for wireless communications is described. The UE may include means for receiving, at the UE, a first SRS configuration that indicates a first SRS resource set associated with an antenna selection usage, means for receiving, at the UE, a second SRS configuration that indicates a second SRS resource set associated with a second usage, where at least one SRS resource is included in both the first SRS resource set and the second SRS resource set, and means for transmitting, by the UE, a plurality of SRSs that includes a first set of SRSs associated with the antenna selection usage and a second set of SRSs associated with the second usage, where at least one SRS of the plurality of SRSs is transmitted via the at least one resource and is included in both the first set of SRSs and the second set of SRSs.

A non-transitory computer-readable medium storing code for wireless communications is described. The code may include instructions executable by one or more processors to receive, at the UE, a first SRS configuration that indicates a first SRS resource set associated with an antenna selection usage, receive, at the UE, a second SRS configuration that indicates a second SRS resource set associated with a second usage, where at least one SRS resource is included in both the first SRS resource set and the second SRS resource set, and transmit, by the UE, a plurality of SRSs that includes a first set of SRSs associated with the antenna selection usage and a second set of SRSs associated with the second usage, where at least one SRS of the plurality of SRSs is transmitted via the at least one resource and is included in both the first set of SRSs and the second set of SRSs

Some examples of the method, UEs, and non-transitory computer-readable medium described herein may further include operations, features, means, or instructions for receiving, at the UE, an indication of a first periodicity scaling factor for the first SRS resource set, where the first SRS resource set has a first periodicity that is based on a base periodicity and the first periodicity scaling factor, and receiving, at the UE, an indication of a second periodicity scaling factor for the second SRS resource set that is different than the first periodicity scaling factor, where the second SRS resource set has a second periodicity that is different than the first periodicity and is based on the base periodicity and the second periodicity scaling factor.

Some examples of the method, UEs, and non-transitory computer-readable medium described herein may further include operations, features, means, or instructions for receiving, at the UE, an indication of one or more SRS measurements, one or more candidate antenna selections, or any combination thereof, where the one or more SRS measurements, the one or more candidate antenna selections, or any combination thereof are based on a most recent SRS associated with the antenna selection usage that is transmitted at least a threshold duration prior to receipt of the indication of the one or more SRS measurements.

In some examples of the method, UEs, and non-transitory computer-readable medium described herein, the one or more SRS measurements, the one or more candidate antenna selections, or any combination thereof are based on a time domain filtering that is reset based on a prior indication of one or more prior SRS measurements, one or more candidate antenna selections, or any combination thereof.

Some examples of the method, UEs, and non-transitory computer-readable medium described herein may further include operations, features, means, or instructions for transmitting, by the UE, an indication of an update to a mapping between at least one antenna port associated with the antenna selection usage and at least one SRS resource of the second SRS resource set, where transmitting the plurality of SRSs is in accordance with the updated mapping.

Some examples of the method, UEs, and non-transitory computer-readable medium described herein may further include operations, features, means, or instructions for receiving, at the UE, an indication of a candidate set of antennas or a SRS measurement report based on the first set of SRSs that is associated with the antenna selection usage, and transmitting, by the UE, an antenna selection report indicating a set of selected antennas for one or more subsequent transmissions, where the set of selected antennas is based on the candidate set of antennas or the SRS measurement report.

In some examples of the method, UEs, and non-transitory computer-readable medium described herein, operations, features, means, or instructions for transmitting the antenna selection report may include operations, features, means, or instructions for transmitting, by the UE, the antenna selection report via an uplink transmission resource that is based on the indication of the candidate set of antennas, the SRS measurement report, or other signaling received by the UE.

In some examples of the method, UEs, and non-transitory computer-readable medium described herein, the second usage is a codebook usage.

Another method for wireless communications by a UE is described. The method may include receiving, at the UE, a first SRS configuration indicating a first SRS resource set, receiving, at the UE, a second SRS configuration indicating a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage, transmitting, by the UE and based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource, and refraining, by the UE and based on the overlap between the occasion of the first SRS resource and the occasion of the second SRS resource, from transmitting a second SRS via the occasion of the second SRS resource in accordance with the prioritization of the first SRS resource over the second SRS resource.

Another UE for wireless communications is described. The UE may include one or more memories storing processor executable code, a transceiver, and one or more processors coupled with the one or more memories. The one or more processors may individually or collectively be operable to execute the code to cause the UE to receive, at the UE via the transceiver, a first SRS configuration indicating a first SRS resource set, receive, at the UE via the transceiver, a second SRS configuration indicating a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage, transmit, by the UE via the transceiver and based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource, and refrain, by the UE and based on the overlap between the occasion of the first SRS resource and the occasion of the second SRS resource, from transmitting a second SRS via the occasion of the second SRS resource in accordance with the prioritization of the first SRS resource over the second SRS resource.

Another UE for wireless communications is described. The UE may include means for receiving, at the UE, a first SRS configuration indicating a first SRS resource set, means for receiving, at the UE, a second SRS configuration indicating a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage, means for transmitting, by the UE and based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource, and means for refraining, by the UE and based on the overlap between the occasion of the first SRS resource and the occasion of the second SRS resource, from transmitting a second SRS via the occasion of the second SRS resource in accordance with the prioritization of the first SRS resource over the second SRS resource.

Another non-transitory computer-readable medium storing code for wireless communications is described. The code may include instructions executable by one or more processors to receive, at the UE, a first SRS configuration indicating a first SRS resource set, receive, at the UE, a second SRS configuration indicating a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage, transmit, by the UE and based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource, and refrain, by the UE and based on the overlap between the occasion of the first SRS resource and the occasion of the second SRS resource, from transmitting a second SRS via the occasion of the second SRS resource in accordance with the prioritization of the first SRS resource over the second SRS resource.

In some examples of the method, UEs, and non-transitory computer-readable medium described herein, the prioritization of the first SRS resource over the second SRS resource is based on a first index value associated with the first SRS resource being lower than a second index value associated with the second SRS resource.

In some examples of the method, UEs, and non-transitory computer-readable medium described herein, the prioritization of the first SRS resource over the second SRS resource is based on a first periodicity associated with the first SRS resource corresponding to a longer period than a second periodicity associated with the second SRS resource.

In some examples of the method, UEs, and non-transitory computer-readable medium described herein, the prioritization of the first SRS resource over the second SRS resource is based on the antenna selection usage associated with the first SRS resource having a higher priority than the second usage associated with the second SRS resource.

Some examples of the method, UEs, and non-transitory computer-readable medium described herein may further include operations, features, means, or instructions for receiving, at the UE, an indication of a candidate set of antennas or a SRS measurement report based on one or more SRSs transmitted via the one SRS resource set that is associated with the antenna selection usage, and transmitting, by the UE, an antenna selection report indicating a set of selected antennas for one or more subsequent transmissions, where the set of selected antennas is based on the candidate set of antennas or the SRS measurement report.

In some examples of the method, UEs, and non-transitory computer-readable medium described herein, operations, features, means, or instructions for transmitting the antenna selection report may include operations, features, means, or instructions for transmitting, by the UE, the antenna selection report via an uplink transmission resource that is based on the indication of the candidate set of antennas, the SRS measurement report, or other signaling received by the UE.

In some examples of the method, UEs, and non-transitory computer-readable medium described herein, the second usage is a codebook usage.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports sounding reference signal (SRS) resource reuse or collision handling and antenna selection reporting in accordance with one or more aspects of the present disclosure.

FIG. 2 shows an example of an SRS resource configuration that supports SRS resource reuse or collision handling and antenna selection reporting in accordance with one or more aspects of the present disclosure.

FIG. 3 shows an example of an SRS resource configuration that supports SRS resource reuse or collision handling and antenna selection reporting in accordance with one or more aspects of the present disclosure.

FIG. 4 shows an example of an SRS resource configuration that supports SRS resource reuse or collision handling and antenna selection reporting in accordance with one or more aspects of the present disclosure.

FIG. 5 shows an example of an SRS resource configuration that supports SRS resource reuse or collision handling and antenna selection reporting in accordance with one or more aspects of the present disclosure.

FIG. 6 shows an example of a process flow that supports SRS resource reuse or collision handling and antenna selection reporting in accordance with one or more aspects of the present disclosure.

FIG. 7 shows an example of a process flow that supports SRS resource reuse or collision handling and antenna selection reporting in accordance with one or more aspects of the present disclosure.

FIGS. 8 and 9 show block diagrams of devices that support SRS resource reuse or collision handling and antenna selection reporting in accordance with one or more aspects of the present disclosure.

FIG. 10 shows a block diagram of a communications manager that supports SRS resource reuse or collision handling and antenna selection reporting in accordance with one or more aspects of the present disclosure.

FIG. 11 shows a diagram of a system including a device that supports SRS resource reuse or collision handling and antenna selection reporting in accordance with one or more aspects of the present disclosure.

FIGS. 12 through 15 show flowcharts illustrating methods that support SRS resource reuse or collision handling and antenna selection reporting in accordance with one or more aspects of the present disclosure.

### DETAILED DESCRIPTION

A wireless device, such as a user equipment (UE), may have a smaller quantity of transmit chains (e.g., sets of circuitry each configured to process a signal and output the processed signal to an antenna for transmission via the antenna) than antennas. For example, the wireless device may have more receive chains (e.g., sets of circuitry each configured to process a signal as received via an antenna for use by the wireless device) than transmit chains, and the wireless device may have an equal quantity of antennas and receive chains. A wireless device with more antennas than transmit chains may be capable of switching which antenna is coupled with which transmit chain. For example, the different antennas may have different physical locations within the wireless device or other different characteristics, such that performance may vary depending on which antennas are coupled with the transmit chains and hence which antennas are used to transmit wireless signals over the air. Accordingly, a wireless device may select which antennas to couple with which transmit chains, and the wireless device may change which antennas are selected over time, in order to improve performance (e.g., provide the highest signal-to-noise ratio (SNR) for over-the-air uplink signals.

To support antenna selection by a UE, the UE may transmit sounding reference signals (SRSs) to a network entity, with each SRS transmitted via one or more antennas. The network entity may perform one or more measurements on the SRSs and transmit to the UE antenna selection information that is based on the one or more measurements. The antenna selection information may include, for example, a set of candidate antenna selection results (e.g., antennas that the network entity proposes that the UE select), measurement information (e.g., the one or more measurements or metrics based thereon), or any combination thereof. The UE may use the antenna selection information received from the network entity to select antennas for use by the UE for one or more subsequent transmissions.

To support SRS transmission by the UE, a UE can receive configuration information from one or more network entities, where the configuration information configures one or more SRS resource sets for use by the UE. An SRS resource may be a set of time and frequency resources that the UE may use to transmit an SRS, and an SRS resource set may be set of one or more SRS resources. SRSs may be used within a wireless communications network for a variety of purposes, including but not limited to inform antenna selection. Accordingly, the configuration information for an SRS resource set may include (e.g., indicate) a corresponding usage for the SRS sets, where the usage of an SRS resource set corresponds to a purpose for which SRSs transmitted via the SRS resources of the SRS resource set will be used. Antenna selection may be one such SRS resource set usage. Other potential SRS resource set usages include beam management (e.g., to support selection of one or more communication beams for use by the UE or a network entity), antenna switching (e.g., related to an ability of the UE to switch the direction of one or more antennas to transmit one or more SRSs using one or more receive antennas, receive chains, or any combination thereof, such as in association with uplink multiple-input-multiple-output (MIMO) transmissions), codebook (e.g., to support selection of one or more codebook-based precoders for use by the UE or a network entity), and non-codebook (e.g., to support selection of one or more non-codebook-based precoders for use by the UE or a network entity).

As the number of different SRS usages increases, the association of different SRS resource sets with different usages may cause one or more inefficiencies or complexities within a wireless communications system. For example, using different SRS resources for different usages may be inefficient or resource-intensive, as separate SRS transmissions may be performed each for a different purpose. Or, as another example, as the number of different SRS usages and associated SRS resource sets increases, the likelihood of collisions (e.g., overlaps in time and frequency) between SRS resources within different SRS resource sets may also increase, increasing the complexity and associated burden of scheduling (e.g., via SRS resource set configuration) by a network entity.

Techniques described herein may improve efficiency within a wireless communications system, among other potential benefits, by allowing for the reuse of one or more SRS resources for two or more usages. For example, an SRS resource may be used for both an antenna selection usage (e.g., to support selection, such as by a UE, of one or more antennas for use by the for one or more subsequent transmissions) and another usage, such as a codebook usage. Additionally, in the event that of a collision between SRS resources configured in a mutually exclusive way for different usages, techniques described herein provide for collision-handling techniques (e.g., one or more prioritization rules that a UE may use to determine which SRS resource to use for an SRS transmission and which SRS resource to drop), which may reduce scheduling complexity or ambiguity within a wireless communications system, among other potential benefits. Techniques described herein also provide for the reporting by a UE of antenna selection results to a network entity, to support improved SRS resource set configuration (e.g., improved determinations of SRS resources that may be reused across multiple SRS resource sets) or other determinations by the network entity, among other potential benefits.

Aspects of the disclosure are initially described in the context of wireless communications systems. Aspects of the disclosure are further illustrated by and described with reference to SRS configuration diagrams, apparatus diagrams, system diagrams, and flowcharts that relate to SRS resource reuse or collision handling and antenna selection reporting.

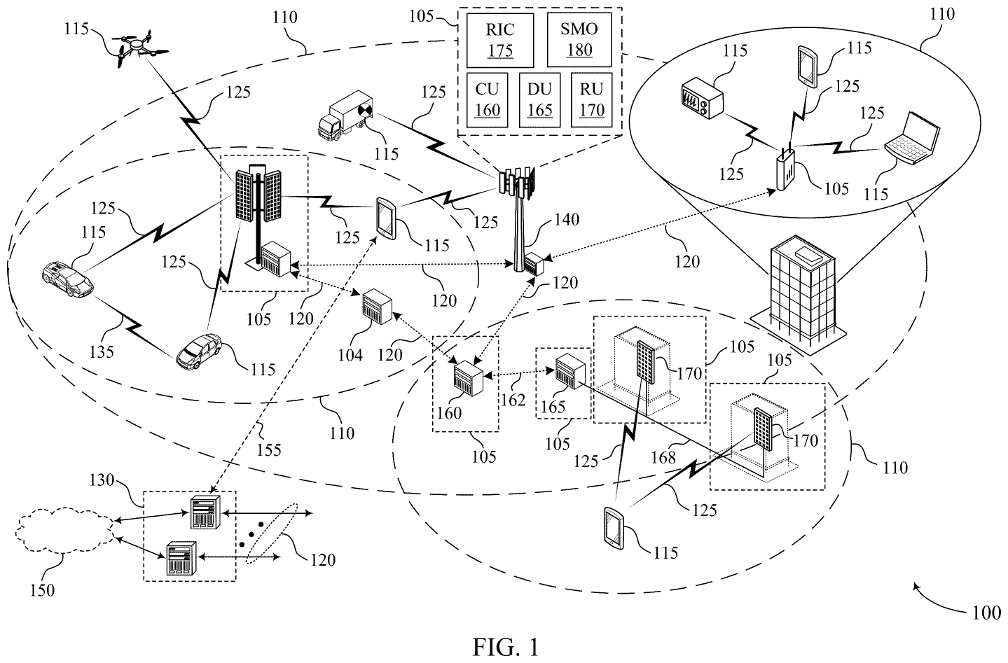

FIG. 1 shows an example of a wireless communications system 100 that supports SRS resource reuse or collision handling and antenna selection reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 of the wireless communications system 100 may be configured with (e.g., may receive configuration information from a network entity 105 that indicates) one or more SRS resources sets, and the UE 115 may transmit SRSs via the SRS resources within those one or more SRS resource sets. Each configured SRS resource set may be associated with a respective usage. In some examples, the same SRS resource may be included in multiple configured SRS resource sets (e.g., an SRS resource may be used for both an antenna selection usage and another usage, such as a codebook usage), and thus an SRS transmitted by the UE 115 via the SRS resource may be associated with each of the multiple usages (e.g., may be used by the network entity 105 and the UE 115 for multiple purposes). In some examples, an SRS resource within one SRS resource set may collide with a different SRS resource within a different SRS resource set, and the UE 115 may transmit an SRS via one of the collided SRS resources while dropping (e.g., refraining from transmitting) an SRS via the other collided SRS resource set in accordance with one or more collision-handling techniques (e.g., prioritization rules) as described herein. Additionally or alternatively, the UE 115 may report one or more selected antennas (e.g., selected for one or more subsequent uplink transmissions, such as physical uplink shared channel transmissions) to network entity 105, to aid in scheduling or configuration determinations by the network entity 105 (e.g., the configuration by the network entity 105 of SRS resource sets that reuse one or more common SRS resources, such as where SRSs transmitted via the SRS resource sets may be used by the network entity 105 in support of decoding the subsequent uplink transmissions).

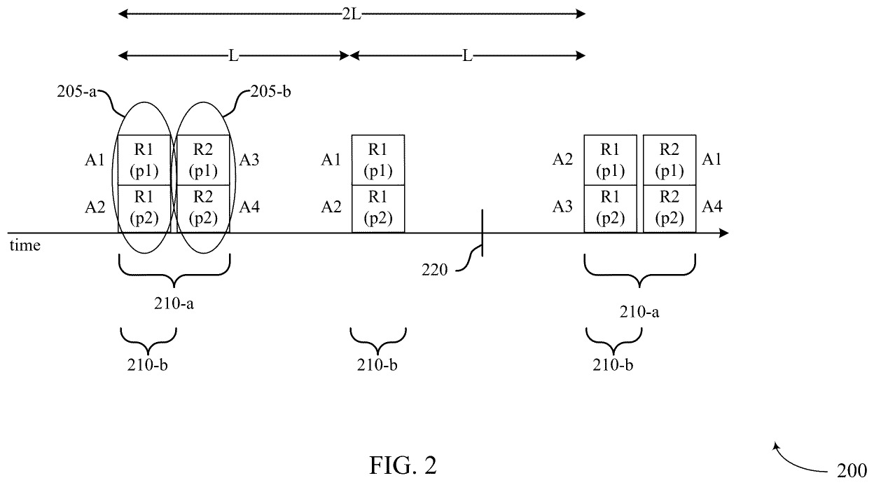

FIG. 2 shows an example of an SRS configuration 200 that supports SRS resource reuse or collision handling and antenna selection reporting in accordance with one or more aspects of the present disclosure. The SRS configuration 200 may include SRS resource sets 210 that each include one or more SRS resources 205. The SRS resource sets 210 may be associated with respective usages, and in some cases, one or more resources 205 may be included in multiple SRS resource sets 210, as discussed herein.

A first SRS resource set 210-a configured for a UE 115 may include two SRS resources 205, a first SRS resource 205-a (which may be referred to as R1) and a second SRS resource 205-b (which may be referred to as R2). R1 may be a two-port SRS resource, and thus each SRS that is transmitted by the UE 115 via (e.g., using) R1 may be transmitted via two antenna ports, where the two antenna ports may be referred to as p1 and p2 respectively. R2 may also be a two-port SRS resource, and thus each SRS that is transmitted by the UE 115 via (e.g., using) R2 may also be transmitted via antenna ports p1 and p2. The first SRS resource set 210-a may have a first usage, which in some examples may be antenna selection (e.g., configuration information for the first SRS resource set 210-a may set a corresponding usage to a first value corresponding to the first usage). The first SRS resource set 210-a may have a period of 2L, and thus SRSs may be transmitted by the UE 115 via the SRS resources 205 within the first SRS resource set 210-a every 2L units of time (e.g., every 2L milliseconds). In some examples, a default or baseline period may be L, and the configuration for an SRS resource set 210 may indicate a periodicity scaling factor K, such that the actual period for the SRS resource set 210 is equal to KL (e.g., for the first SRS resource set 210-a, K=2 and thus the period is 2L).

A second SRS resource set 210-b configured for a UE 115 may include one SRS resource 205, which may be the first SRS resource 205-a (R1). The second SRS resource set 210-b may have a second usage, which in some examples may be codebook (e.g., configuration information for the first SRS resource set 210-a may set a corresponding usage to a second value corresponding to the second usage). The second SRS resource set 210-a may have a period of L, and thus SRSs may be transmitted by the UE 115 via the SRS resources 205 within the second SRS resource set 210-b every L units of time (e.g., for the second SRS resource set 210-b, K=1 and thus the period is L).

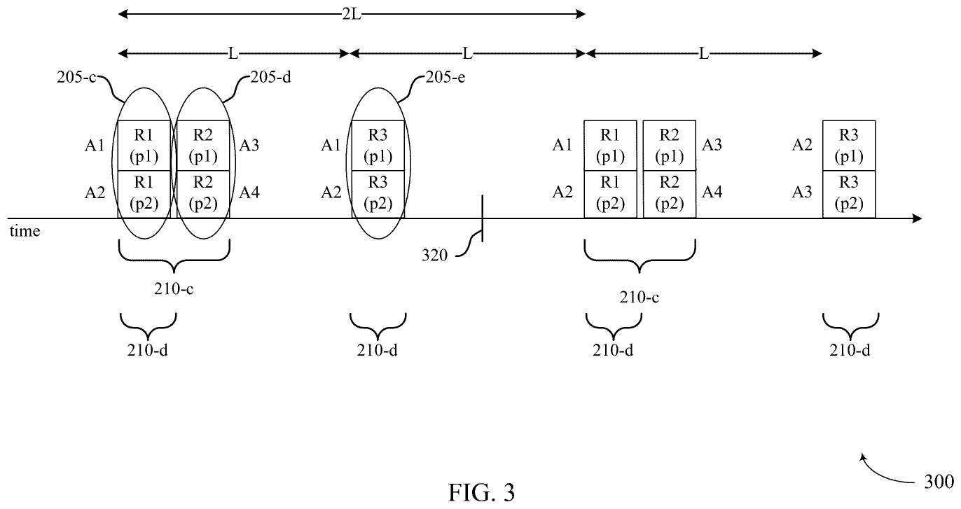

Thus, the first SRS resource 205-a (R1) may be included in both the first SRS resource set 210-a and the second SRS resource set 210-b and hence may be described as being reused. Accordingly, some SRSs transmitted via R1 may be used by a receiving network entity for two usages (e.g., for both the first usage of the first SRS resource set 210-a and the second usage of the second SRS resource set 210-b, such as for both an antenna selection usage and a codebook usage). For instance, in the example illustrated in FIG. 3, every 2L time units, an SRS transmitted via R1 may be a dual-usage (e.g., dual-purpose) SRS. Such reuse of an SRS resource may provide improved efficiency with respect to the utilization of SRS resources as well as other processing or transmission resources, among other potential benefits.

In some examples, the antennas used to transmit SRSs may change between one instance of an SRS resource 205 (or SRS resource set 210) and a subsequent instance of the SRS resource 205 (or SRS resource set 210). For instance, in the example illustrated in FIG. 3, the SRSs transmitted via two earlier instances of R1 may be transmitted via antennas A1 and A2, and an SRS transmitted via an earlier instance of R2 may be transmitted via antenna A3 and A4, but a change in active antennas (e.g., a change in an antenna-to-resource (A2R) mapping) may occur at time 220. After the change, an SRS transmitted via a later instance of R1 may be transmitted via antennas A2 and A3, and an SRS transmitted via a later instance of R2 may be transmitted via antennas A1 and A4.

A change in active antennas may introduce ambiguities or other complications (e.g. inaccuracies) associated with time-domain filtering across two or more consecutive SRSs that may be used by a network entity receiving the SRSs (e.g., to evaluate one or more metrics such as reference signal received power (RSRP) for the SRSs, which in some examples may be per-antenna and per-SRS RSRPs, or to make one or more determinations based on the SRSs such as a set of candidate antenna selections). To mitigate such issues, one or more techniques as described herein may be used.

In some examples, the SRS measurement or candidate antenna selection results may be calculated by the network entity based on the single most recent antenna selection SRS that is received by the network entity at least N milliseconds before the antenna selection indication, without time-domain filtering being used by the network entity 105. Or, in some examples, such as for an antenna selection operation, time-domain filtering at the network entity 105 may be reset after an antenna selection indication is transmitted by the network entity 105 (e.g., that indicates SRS measurements reporting or candidate antenna selection results reporting). Thus, an antenna selection indication may not be determined or calculated based on time-domain SRS filtering across a set of SRSs that includes any SRSs transmitted before the most recent previous antenna selection indication. Additionally or alternatively, in some examples, the UE 115 may transmit to the network entity 105 a notification (e.g., a single-bit notification) indicating whether the A2R mapping for the SRS transmissions has changed or if it remains the same (e.g., whether the active antenna set is changed or not)—the UE 115 may transmit such a notification, for example, in response to receiving antenna selection information from the network entity 105. If such a notification indicates that the mapping has changed, the network entity 105 may not subsequently apply time-domain filtering across a set of SRSs that includes any SRSs transmitted before the notification. Such a notification may be transmitted by the UE, for example, via a medium access control (MAC) control element (CE) (MAC-CE) or a physical uplink control channel (PUCCH).

FIG. 3 shows an example of an SRS configuration 300 that supports SRS resource reuse or collision handling and antenna selection reporting in accordance with one or more aspects of the present disclosure. The SRS configuration 300 may include SRS resource sets 210 that each include one or more SRS resources 205. The SRS resource sets 210 may be associated with respective usages, and in some cases, two or more SRS resource sets 210 may be mutually exclusive with respect to the one or more SRS resources 205 therein—that is, two or more SRS resource sets 210 may each include a different respective set of one or more SRS resources 205, with no SRS resource 205 included in more than one of the two or more SRS resource sets 210.

A first SRS resource set 210-c configured for a UE 115 may include two SRS resources 205, a first SRS resource 205-c (which may be referred to as R1) and a second SRS resource 205-d (which may be referred to as R2). R1 may be a two-port SRS resource, and thus each SRS that is transmitted by the UE 115 via (e.g., using) R1 may be transmitted via two antenna ports, where the two antenna ports may be referred to as p1 and p2 respectively. R2 may also be a two-port SRS resource, and thus each SRS that is transmitted by the UE 115 via (e.g., using) R2 may also be transmitted via antenna ports p1 and p2. The first SRS resource set 210-c may have a first usage, which in some examples may be antenna selection (e.g., configuration information for the first SRS resource set 210-c may set a corresponding usage to a first value corresponding to the first usage). The first SRS resource set 210-c may have a period of 2L, and thus SRSs may be transmitted by the UE 115 via the SRS resources 205 within the first SRS resource set 210-c every 2L units of time (e.g., every 2L milliseconds). In some examples, a default or baseline period may be L, and the configuration for an SRS resource set 210 may indicate a periodicity scaling factor K, such that the actual period for the SRS resource set 210 is equal to KL (e.g., for the first SRS resource set 210-c, K=2 and thus the period is 2L).

A second SRS resource set 210-d configured for a UE 115 may include one SRS resource 205, which may be a third SRS resource 205-d (R3). R3 may also be a two-port SRS resource, and thus each SRS that is transmitted by the UE 115 via (e.g., using) R3 may also be transmitted via antenna ports p1 and p2. The second SRS resource set 210-d may have a second usage, which in some examples may be codebook (e.g., configuration information for the first SRS resource set 210-c may set a corresponding usage to a second value corresponding to the second usage). The second SRS resource set 210-c may have a period of L, and thus SRSs may be transmitted by the UE 115 via the SRS resources 205 within the second SRS resource set 210-d every L units of time (e.g., for the second SRS resource set 210-d, K=1 and thus the period is L).

Thus, the first SRS resource set 210-c and the second SRS resource set 210-d may be mutually exclusive, with no SRS resource 205 included in both the first SRS resource set 210-c and the second SRS resource set 210-d. In some scenarios (e.g., due to the respective periodicities of the SRS resource sets 210 or other scheduling- or configuration-related reasons), an SRS transmission occasion associated with an SRS resource 205 within one SRS resource set 210 may collide (e.g., be at least partially overlapping in time and frequency) with an SRS resource 205 within another SRS resource set 210. For instance, in the example illustrated in FIG. 3, every other instance of an SRS transmission via the R3 SRS resource 205-e may collide with (e.g., be scheduled to occur at the same time and frequency as) a corresponding instance of an SRS transmission via the R1 SRS resource 205-c. In such cases, a UE 115 may use one or rules to handle such a collision (e.g., to determine which SRS to transmit and which SRS to drop, such as whether to transmit the SRS via the R1 SRS resource 205-c and drop the SRS via the R3 SRS resource 205-e, or to transmit the SRS via the R3 SRS resource 205-c and drop the SRS via the R1 SRS resource 205-c).

In some examples, an SRS resource 205 with a relatively lower index value may have higher priority than an SRS resource 205 with a relatively higher index value. Thus, for example, where R1 has an index value of 1, R2 has an index value of 2, and R3 has an index value of 3, R1 may have a higher priority than R3. Accordingly, the UE 115 may prioritize SRS transmissions via R1 over SRS transmissions via R3, and thus in the event of a collision between respective instances of R1 and R3, the UE 115 may transmit an SRS via the instance of R1 and refrain from transmitting (e.g., drop) an SRS that otherwise would have been transmitted via the colliding instance of R3. Prioritization based on index value may allow a network entity 105 to configure SRS transmission priority between different SRS resource sets 210 based on which SRS resources 205 are included in a particular SRS resource set 210, which may reduce complexity, improve efficiency (e.g., avoid the need for separate prioritization-related signaling or indications), or both, among other potential benefits.

Additionally or alternatively, in some examples, an SRS resource 205 with a relatively longer period may have higher priority than an SRS resource 205 with a relatively shorter period. Thus, for example, where R1 and R2 each have a period of 2L (e.g., due to the period of the first SRS resource set 210-c being 2L), and R3 has a period of L (e.g., due to the period of the second SRS resource set 210-d being L), R1 may have a higher priority than R3. Accordingly, the UE 115 may prioritize SRS transmissions via R1 over SRS transmissions via R3, and thus in the event of a collision between respective instances of R1 and R3, the UE 115 may transmit an SRS via the instance of R1 and refrain from transmitting (e.g., drop) an SRS that otherwise would have been transmitted via the colliding instance of R3. Prioritization based on having a relatively longer period may prevent the longer-period SRS resource 205 from never being utilized (e.g., in the example illustrated in FIG. 3, were the shorter-period R3 prioritized over the longer-period R1, no SRSs would ever be transmitted via R1), among other potential benefits.

Additionally or alternatively, priority between colliding SRS resources 205 may be based on the respective usages of the corresponding SRS resource sets 210. For example, the antenna selection usage may have a higher priority than the second usage (e.g., codebook usage). Accordingly, the UE 115 may prioritize SRS transmissions via R1 over SRS transmissions via R3, and thus in the event of a collision between respective instances of R1 and R3, the UE 115 may transmit an SRS via the instance of R1 and refrain from transmitting (e.g., drop) an SRS that otherwise would have been transmitted via the colliding instance of R3. Prioritization based on usage may ensure alignment between which SRSs are dropped and the relative priority (e.g., time-sensitivity) to a network entity 105 of the different SRS usages, among other potential benefits.

In some examples, the antennas used to transmit SRSs may change between one instance of an SRS resource 205 (or SRS resource set 210) and a subsequent instance of the SRS resource 205 (or SRS resource set 210). For instance, in the example illustrated in FIG. 3, the SRSs transmitted via an earlier instances of R3 may be transmitted via antennas A1 and A2, but a change in active antennas (e.g., a change in an antenna-to-resource (A2R) mapping) may occur at time 320. After the change, an SRS transmitted via a later instance of R3 may be transmitted via antennas A2 and A3. In some examples, a change in active antennas may occur for one SRS resource set 210 but not for another SRS resource set 210—e.g., in the example FIG. 3, the change in active antennas at time 420 impacts the second SRS resource set 210-d but does not impact the first SRS resource set 210-c.

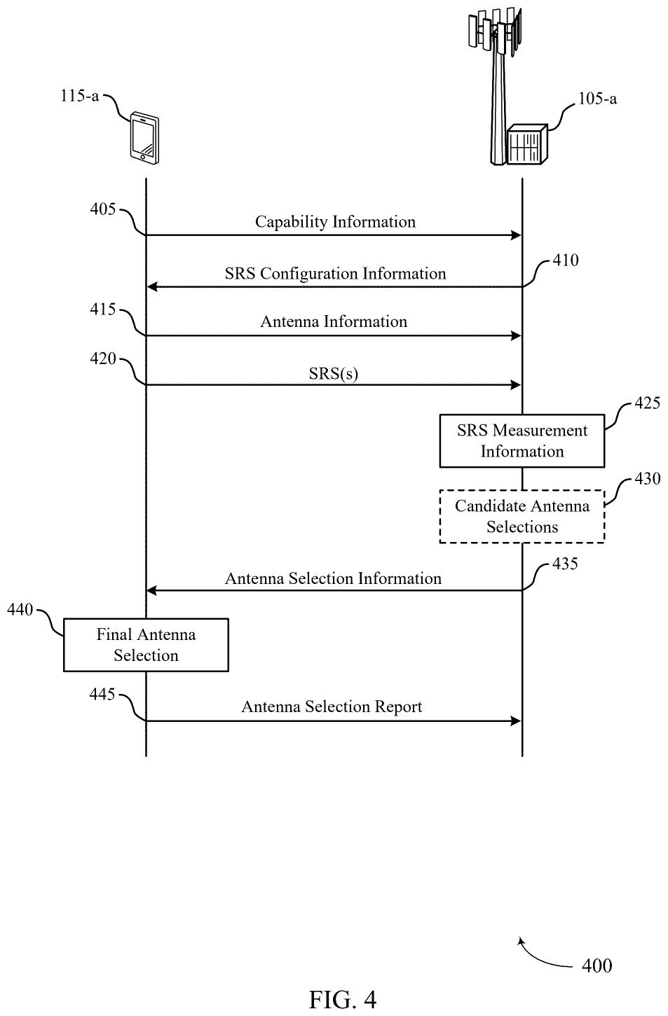

FIG. 4 shows an example of a process flow 400 that supports SRS resource reuse or collision handling and antenna selection reporting in accordance with one or more aspects of the present disclosure. The process flow 400 may implement aspects of or may be implemented by aspects of the wireless communications system 100. For example, the process flow 400 may be implemented by a UE 115-a and a network entity 105-a, which may be an example of a UE 115 and a network entity 105 as described herein. Although the following description of the process flow 400 describes operations as occurring in one example order, the operations performed by the UE 115-a and the network entity 105-a may be performed in different orders or at different times than the exemplary order shown in FIG. 4. Additionally or alternatively, some operations may be omitted from the process flow 400, or other operations may be added to the process flow 400. Further, while operations in the process flow 400 are illustrated as being performed by the UE 115-a and the network entity 105-a, the examples herein are not to be construed as limiting, and in some examples, the described features may be associated with a different type or quantity of devices. The process flow 400 may be an example of a closed-loop antenna selection process.

At 405, the UE 115-a may transmit, to the network entity 105-a, capability information in support of antenna selection. The capability information may include, for example, a quantity of transmit chains included in the UE 115-a, a quantity of receive chains included in the UE 115-a, a quantity of antennas included in the UE 115-a, or any combination thereof.

At 410, the network entity 105-a may transmit, to the UE 115-a, SRS configuration information. The SRS configuration information may include, for example, information that indicates one or more SRS resource sets, each associated with a respective usage and each including at least one SRS resource. The one or more SRS resource sets configured at 410 may include at least one SRS resource set with a usage of antenna selection. At least two SRS resource sets configured at 410 may be overlapping (e.g., with at least one reused (common) SRS resource included in multiple SRS resource sets, as described, for example, with reference to FIG. 3 herein). Additionally or alternatively, at least two SRS resource sets configured at 410 may be mutually exclusive (e.g., without any SRS resource included in more than one SRS resource set, as described, for example, with reference to FIG. 4 herein). The SRS configuration information may further include, for example, information that indicates a respective periodicity for each configured SRS resource set.

At 415, the UE 115-a may transmit antenna information to the network entity 105-a. The antenna information may include, for example, a power headroom report for each antenna at the UE 115 or for each antenna that the UE 115 will use to transmit one or more SRSs in accordance with the SRS configuration information received at 410.

At 420, the UE 115-a may transmit, to the network entity 105-a, one or more SRSs via one or more SRS resources included within the one or more SRS resource sets configured at 410.

At 425, the network entity 105-a may obtain (e.g., measure or determine) SRS measurement information based on the one or more SRSs transmitted by the UE 115-a at 420. The SRS measurement information may include, for example, a per-antenna RSRP for each SRS (which may be referred to as a per-antenna SRS-RSRP), antenna correlation information (e.g., metrics), or any combination thereof.

At 430, the network entity 105-a may determine one or more candidate antenna selections based on the SRS measurement information. For example, the network entity 105-a may determine one or more candidate antennas that the network entity 105-a proposes (e.g., recommends) that the UE 115-a select (e.g., for the UE 115-a to use for one or more subsequent uplink transmissions by the UE 115-a, such as for one or more subsequent PUSCH transmissions).

At 435, the network entity 105-a may transmit, antenna selection information to the UE 115-a, which may be based on the SRS measurement information obtained at 425, the one or more candidate antenna selections determined at 430, or both. The antenna selection information may include, for example, the SRS measurement information. Additionally or alternatively, in examples where the network entity 105-a determines one or more candidate antenna selections at 430, the antenna selection information may include, for example, the one or more candidate antenna selections. The SRS measurement information obtained at 425, the one or more candidate antenna selections determined at 430, or any combination thereof may be based on a time domain filtering that was reset based on a prior transmission of antenna selection information.

At 440, the UE 115-a may perform a final antenna selection (e.g., may select one or more antennas to use for one or more subsequent uplink transmissions by the UE 115-a). The final antenna selection may be based on the antenna selection information 435 or additional information (e.g., one or more additional parameters or metrics that the UE 115-a may obtain, such as parameters or metrics related to power consumption or maximum permissible exposure). In examples where the network entity 105-a determines one or more candidate antenna selections at 430, the one or more antennas selected by the UE 115-a at 440 may be the same as or different than the one or more candidate antenna selections determined by the network entity 105-a.

At 445, the UE 115-a may transmit an antenna selection report to the network entity 105-a. The antenna selection report may indicate the one or more antennas selected at 440. The UE 115-a may couple, within the UE 115, one or more transmit chains with the one or more selected antennas (e.g., in a one-to-one fashion) and subsequently perform one or more uplink transmissions (e.g., PUSCH transmissions) using the one or more transmit chains and the one or more selected antennas. The antenna selection report may indicate, for example, an update to a mapping between at least one antenna port associated with at least one usage (e.g., the antenna selection usage) and at least one SRS resource of the configured SRS resource sets. A subsequent SRS may be transmitted (e.g., as part of a subsequent iteration of the process flow 400 in accordance with the updated mapping.

Receipt by the network entity 105-a of the antenna selection report that indicates antennas selected at 440 for one or more subsequent transmissions may support (e.g., facilitate, enable, or improve the ability of) the network entity 105-a to configure SRS resource sets associated with the one or more subsequent transmissions (e.g., sets of SRS resources via which SRSs used by the network entity 105-a to decode the one or more subsequent transmissions will be transmitted). For example, knowledge of the antennas selected at 440 may support the network entity 105-a in configuring overlapping SRS resource sets of different usages where at least one SRS resource is included in multiple SRS resource sets.

In some examples, the antenna selection report may indicate a respective index for each selected antenna. For example, for each transmit chain included in the UE 115-a, the UE 115-a may indicate an antenna index that corresponds to the antenna to which that transmit chain will be coupled. Thus, if the UE 115-a includes p transmit chains and q antennas, then the antenna selection report may indicate a respective group of [log₂ q] bits for each antenna chain, for a total of p. [log₂ q] bits that represents p antennas (from among the q total antennas) that are to be connected to the p chains. As one such example, if the UE 115-a includes two transmit chains (p=2) and four antennas (q=4), then the antenna selection report may indicate a total of four bits with one group of two bits (e.g., the first two bits from among the four bits) indicating a first index value associated with one of the four antennas, which will be coupled with the first transmit chain, and another group of two bits (e.g., the final two bits from among the four bits) indicating a second index value associated with another of the four antennas, which will be coupled with the second transmit chain.

Or, in some examples, the antenna selection report may indicate a single index value that corresponds to a set of selected antennas. For example, the index value may correspond to a particular row of an antenna selection table, where the row may correspond to the set of selected antennas. The number of bits included in the index value (and correspondingly, the number of rows in the antenna selection table if applicable) may depend on whether set of selected antennas is in ordered set (e.g., [log₂ N] bits where N=C(q, p) if the members of the set of selected antennas are indicated without regard to which selected antenna corresponds to which transmit chain, or [log₂ N] bits where N=P(q, p) if which antenna is selected for which transmit chain is indicated). An example antenna selection table showing index values and corresponding unordered sets of antennas is shown below as Table 1, and an example antenna selection table showing index values and corresponding ordered sets of antennas is shown below as Table 2.

TABLE 1
Antenna Selection Table for Unordered Sets of Antennas

| Index Value | Selected Antennas |
|---|---|
| 1 | (1, 2) |
| 2 | (1, 3) |
| 3 | (1, 4) |
| 4 | (2, 3) |
| 5 | (2, 4) |
| 6 | (3, 4) |

TABLE 2
Antenna Selection Table for Ordered Sets of Antennas

| Index Value | Selected Antennas |
|---|---|
| 1 | (1, 2) |
| 2 | (1, 3) |
| 3 | (1, 4) |
| 4 | (2, 1) |
| 5 | (2, 3) |
| 6 | (2, 4) |
| 7 | (3, 1) |
| 8 | (3, 2) |
| 9 | (3, 4) |
| 10 | (4, 1) |
| 11 | (4, 2) |
| 12 | (4, 3) |

In some examples, the antenna selection report may indicate a selected of antennas from among multiple sets of candidate antennas previously indicated to the UE 115-a by the network entity 105-a as part of the antenna selection information at 435. For example, the network entity 105-a may indicate M sets of candidate antennas as part of the antenna selection information at 435, the UE 115-a may select one of the M sets of candidate antennas at 440, and the antenna selection report at 445 may indicate the selected antenna set (e.g., by indicating [log₂ M] bits representative of an index value corresponding to the selected one of the M sets of candidate antennas). The value of M may be indicated to the UE 115-a by the network entity 105 as part of one of the messages shown in FIG. 4 or as part of a separate message, or the value of M may be specified a priori (e.g., in a standard).

In some examples, the UE 115-a may transmit the antenna selection report at 445 via an instance of periodic resource (e.g., a PUCCH or PUSCH resource) that is configured for antenna selection reporting. The periodic resource may be indicated the UE 115-a by the network entity 105-a or another network entity 105 (e.g., via RRC signaling). In some examples, the antenna selection report at 445 may indicate the active antennas (e.g., as selected at 440) as of a particular time before the instance of the periodic resource via which the antenna selection report is transmitted at 445 (e.g., the antenna selection may indicate the active antennas as of X slots prior to the resource used to transmit the antenna selection report). The time separation (e.g., X) may be indicated the UE 115-a by the network entity 105-a or another network entity 105 (e.g., via RRC signaling) or may be specified a priori (e.g., in a standard).

In some examples, the UE 115-a may determine a resource (e.g., a PUCCH or PUSCH resource) to use to transmit the antenna selection report at 445 based on when the antenna selection information received at 435. For example, the UE 115-a may transmit the antenna selection report at 445 at some time offset after (e.g., Y slots after) the antenna selection information is received at 435. The time offset (e.g., Y) may be indicated the UE 115-a by the network entity 105-a or another network entity 105 (e.g., via RRC signaling or as part of the antenna selection information at 435) or may be specified a priori (e.g., in a standard). A frequency domain resource, a code domain resource, or both for the UE 115-a to use to transmit the antenna selection report at 445 may be indicated to the UE 115-a by the network entity 105-a or another network entity 105 (e.g., via RRC signaling or as part of the antenna selection information at 435).

In some examples, the resource used by the UE 115-a to transmit the antenna selection report at 445 may be indicated by via a grant message from the network entity 105-a. For example, the grant message may schedule a downlink transmission to the UE 115-a, and the grant message may include a triggering indication (e.g., triggering bit) that indicates whether the UE 115-a is to transmit an antenna selection report.

If the triggering indication indicates that the UE 115-a is to transmit an antenna selection report, then in some examples, the UE 115-a may transmit the antenna selection report together with HARQ feedback (e.g., an acknowledgement (ACK) or negative acknowledgment (NACK)) for the downlink transmission that is scheduled by the grant message. In some such examples, a separation in time between a slot in which the downlink transmission is scheduled and a slot in which the HARQ feedback is transmitted may be different for scenarios in which an antenna selection report is also transmitted (e.g., the separation may be K′ in such scenarios) versus scenarios in which antenna selection report is not transmitted (e.g., the separation may be K in such scenarios). Or, in some examples, if the triggering indication indicates that the UE 115-a is to transmit an antenna selection report, then the UE 115-a may transmit the antenna selection report separate from HARQ feedback (e.g., an acknowledgement (ACK) or negative acknowledgment (NACK)) for the downlink transmission that is scheduled by the grant message, with a first separation in time between a slot in which the downlink transmission is scheduled and a slot in which the HARQ feedback is transmitted (e.g., K) different than a second separation in time between the slot in which the downlink transmission is scheduled and a slot in which the antenna selection report is transmitted (e.g., K″). Such separations in time (e.g., K, K′, or K″) may be indicated to the UE 115-a by the network entity 105-a or another network entity 105 (e.g., via RRC signaling or as part of the antenna selection information at 435) and in some examples have values that depend on a capability of the UE 115-a.

In some examples, the UE 115-a may transmit the antenna selection report at 445 via a MAC-CE or RRC message. In some such examples, if the UE 115-a does not receive an indication (e.g., an associated scheduling message) to retransmit the antenna selection report within some time period after transmitting the antenna selection report, then the UE 115-a may determine that the antenna selection report has been received, that the associated one or more antenna selections therein are valid, or both. Or, in some such examples, the UE 115-a may determine that the antenna selection report has been received, that the associated one or more antenna selections therein are valid, or both based on subsequent receive of an affirmative (e.g., ACK) message from the network entity 105-a, such as an affirmative message received within some time period after transmission of the antenna selection report at 445. Such time periods (e.g., during which the UE 115-a may monitor for a retransmission request or an affirmative message) may be indicated to the UE 115-a by the network entity 105-a or another network entity 105 (e.g., via RRC signaling or as part of the antenna selection information at 435) and in some examples have values that depend on a capability of the UE 115-a.

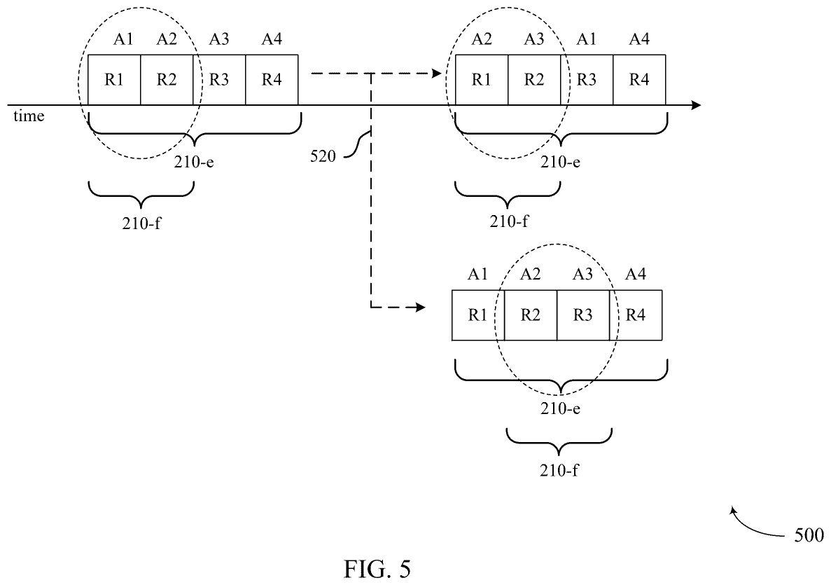

FIG. 5 shows an example of an SRS configuration 500 that supports SRS resource reuse or collision handling and antenna selection reporting in accordance with one or more aspects of the present disclosure. The SRS configuration 500 may include SRS resource sets 210 that each include one or more SRS resources 205. The SRS resource sets 210 may be associated with respective usages, and in some cases, one or more resources 205 may be included in multiple SRS resource sets 210, as discussed herein.

As of a first (earlier) time, a first SRS resource set 210-e configured for a UE 115 may include four SRS resources 205, which may be referred to as R1, R2, R3, and R4 respectively. The first SRS resource set 210-e may have a first usage, which in some examples may be antenna selection (e.g., configuration information for the first SRS resource set 210-e may set a corresponding usage to a first value corresponding to the first usage). Also, as of the first time, a second SRS resource set 210-f configured for a UE 115 may include two SRS resources 205, which may be the same R1 and R2 that are also included in the first SRS resource set 210-e. The second SRS resource set 210-b may have a second usage, which in some examples may be codebook (e.g., configuration information for the first SRS resource set 210-a may set a corresponding usage to a second value corresponding to the second usage).

At time 520, a change in active antennas (e.g., for the second SRS resource set 210-f) may occur. For example, prior to time 520, SRSs transmitted via SRS resources 205 within the second SRS resource set 210-f may be transmitted via antennas A1 and A2 respectively, and after time 520 SRSs transmitted via SRS resources 205 within the second SRS resource set 210-f may be transmitted via antennas A2 and A3 respectively. Reporting by the UE 115 of such a change in active antennas associated with the second SRS resource set 210-f (e.g., via an antenna selection report as described with reference to FIG. 4) may support (e.g., facilitate, enable) a network entity 105 in making one or more responsive updates to an SRS resource set configuration for the UE 115-a—e.g., to maintain compatibility between the two overlapped SRS resource sets 210 that share one or more common SRS resources 205 and avoid introducing one or more additional SRS resources 205 into either SRS resource sets 210, among other potential benefits.

In some examples, in response to a report by the UE 115 of a change in active antennas associated with one overlapped SRS resource set 210, the network entity 105 may determine an updated resource-to-antenna mapping for other SRS resources 205 within another overlapped SRS resource set 210. For example, as shown in the upper scenario of FIG. 5, in response to a change in active antennas for R1 and R2 within the second SRS resource set 210-f from A1 and A2 to A2 and A3, the active antennas for R3 and R4 within the first SRS resource set 210-e can be updated to A1 and A4 respectively. Thus, which resources are common as between the first SRS resource set 210-e and the second SRS resource set 210-f may remain unchanged, but the resource-to-antenna mapping may be updated for both SRS resource sets 210.

Or, in some examples, in response to a report by the UE 115 of a change in active antennas associated with one overlapped SRS resource set 210, the network entity 105 may update which SRS resources 205 are in which SRS resource set 210. For example, as shown in the lower scenario of FIG. 5, in response to a change in active antennas for the second SRS resource set 210-f from A1 and A2 to A2 and A3, the second SRS resource set 210-f may be updated to include R2 and R3 (which were already mapped to A2 and A3 prior to time 520), and the resource-to-antenna mappings for both SRS resource sets 210 may be maintained (not updated). Thus, which resources of the first SRS resource set 210-e are also included in the second SRS resource set 210-f may be updated, while the resource-to-antenna mapping may be maintained for all SRS resources 205 within either SRS resource set 210.

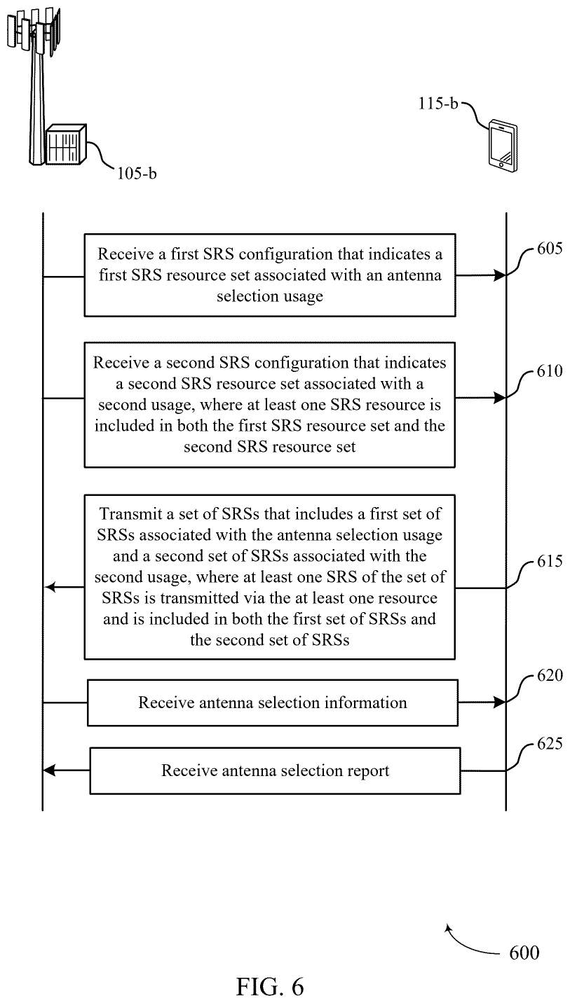

FIG. 6 shows an example of a process flow 600 that supports SRS resource reuse or collision handling and antenna selection reporting in accordance with one or more aspects of the present disclosure. The process flow 600 may implement aspects of or may be implemented by aspects of the wireless communications system 100. For example, the process flow 600 may be implemented by a UE 115-b and a network entity 105-b, which may be an example of a UE 115 and a network entity 105 as described herein. Although the following description of the process flow 600 describes operations as occurring in one example order, the operations performed by the UE 115-b and the network entity 105-b may be performed in different orders or at different times than the exemplary order shown in FIG. 6. Additionally or alternatively, some operations may be omitted from the process flow 600, or other operations may be added to the process flow 600. Further, while operations in the process flow 600 are illustrated as being performed by the UE 115-b and the network entity 105-b, the examples herein are not to be construed as limiting, and in some examples, the described features may be associated with a different type or quantity of devices. The process flow 600 may be an example of a closed-loop antenna selection process.

At 605, the UE 115-b may receive a first SRS configuration that indicates a first SRS resource set associated with an antenna selection usage. At 610 the UE 115-b may receive a second SRS configuration that indicates a second SRS resource set associated with a second usage, where at least one SRS resource is included in both the first SRS resource set and the second SRS resource set. The second usage may be a codebook usage.

At 615, the UE 115-b may transmit a set of SRSs that includes a first set of SRSs associated with the antenna selection usage and a second set of SRSs associated with the second usage, where at least one SRS of the set of SRSs is transmitted via the at least one resource and is included in both the first set of SRSs and the second set of SRSs.

In some examples, the UE 115-b may receive an indication of a first periodicity scaling factor for the first SRS resource set, where the first SRS resource set has a first periodicity that is based on a base periodicity and the first periodicity scaling factor. The UE 115-b may also receive an indication of a second periodicity scaling factor for the second SRS resource set that is different than the first periodicity scaling factor, where the second SRS resource set has a second periodicity that is different than the first periodicity and is based on the base periodicity and the second periodicity scaling factor.

In some examples, the UE 115-c may receive an indication of one or more SRS measurements, one or more candidate antenna selections, or any combination thereof, where the one or more SRS measurements, the one or more candidate antenna selections, or any combination thereof are based on a most recent SRS associated with the antenna selection usage that is transmitted at least a threshold duration prior to receipt of the indication of the one or more SRS measurements. The one or more SRS measurements, the one or more candidate antenna selections, or any combination thereof may be based on a time domain filtering that is reset based on a prior indication of one or more prior SRS measurements, one or more candidate antenna selections, or any combination thereof.

In some examples, the UE 115-b may transmit (e.g., prior to 615) an indication of an update to a mapping between at least one antenna port associated with the antenna selection usage and at least one SRS resource of the second SRS resource set, where transmitting the set of SRSs is in accordance with the updated mapping.

At 620, the UE 115-c may receive antenna selection information, which may include an indication of a candidate set of antennas or an SRS measurement report based on the first set of SRSs that is associated with the antenna selection usage.

At 625, the UE 115-c may transmit an antenna selection report indicating a set of selected antennas for one or more subsequent transmissions, where the set of selected antennas is based on the antenna selection information (e.g., the candidate set of antennas or the SRS measurement report). The antenna selection report may be transmitted via an uplink transmission resource that is based on the antenna selection information or other signaling received by the UE.

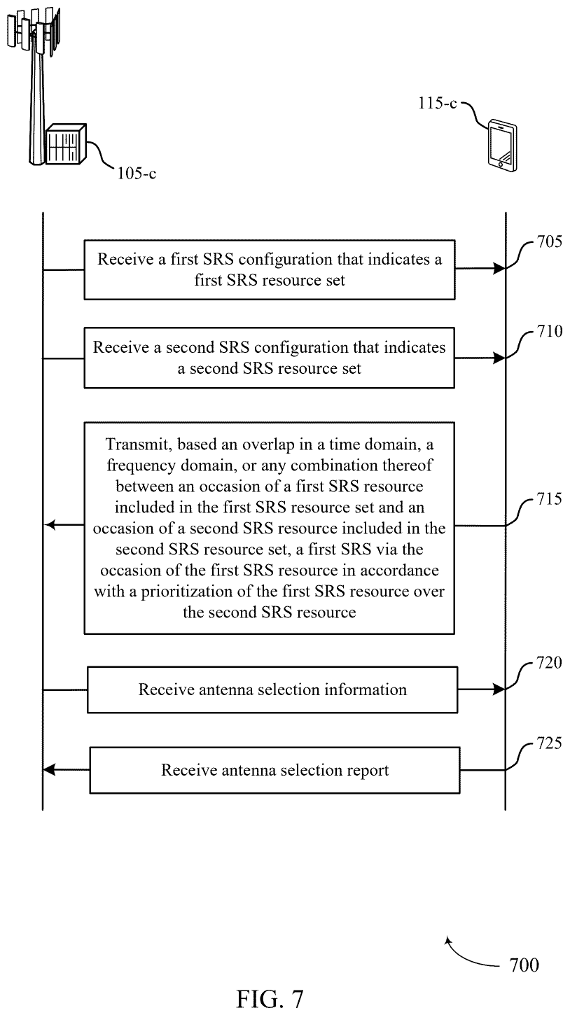

FIG. 7 shows an example of a process flow 700 that supports SRS resource reuse or collision handling and antenna selection reporting in accordance with one or more aspects of the present disclosure. The process flow 700 may implement aspects of or may be implemented by aspects of the wireless communications system 100. For example, the process flow 700 may be implemented by a UE 115-c and a network entity 105-c, which may be an example of a UE 115 and a network entity 105 as described herein. Although the following description of the process flow 700 describes operations as occurring in one example order, the operations performed by the UE 115-c and the network entity 105-c may be performed in different orders or at different times than the exemplary order shown in FIG. 7. Additionally or alternatively, some operations may be omitted from the process flow 700, or other operations may be added to the process flow 700. Further, while operations in the process flow 700 are illustrated as being performed by the UE 115-c and the network entity 105-c, the examples herein are not to be construed as limiting, and in some examples, the described features may be associated with a different type or quantity of devices. The process flow 700 may be an example of a closed-loop antenna selection process.

At 705, the UE 115-c may receive a first SRS configuration that indicates a first SRS resource set. At 710 the UE 115-c may receive a second SRS configuration that indicates a second SRS resource set. One SRS resource set from among the first SRS resource set and the second SRS resource set may be associated with an antenna selection usage, and another SRS resource set from among the first SRS resource set and the second SRS resource set may be associated with a second usage. The second usage may be a codebook usage.

At 715, the UE 115-b may transmit, based on an overlap (e.g., in a time domain, a frequency domain, or any combination thereof) between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource. The UE 115-b also may refrain, based on the overlap between the occasion of the first SRS resource and the occasion of the second SRS resource, from transmitting a second SRS via the occasion of the SRS resource in accordance with the prioritization of the first SRS resource over the second SRS resource.

In some examples, the prioritization of the first SRS resource over the second SRS resource may be based at least in part on a first index value associated with the first SRS resource being lower than a second index value associated with the second SRS resource.

In some examples, the prioritization of the first SRS resource over the second SRS resource may be based on a first periodicity associated with the first SRS resource corresponding to a longer period than a second periodicity associated with the second SRS resource.

In some examples, the prioritization of the first SRS resource over the second SRS resource may be based on the antenna selection usage associated with the first SRS resource having a higher priority than the second usage associated with the second SRS resource.

At 720, the UE 115-c may receive antenna selection information, which may include an indication of a candidate set of antennas or an SRS measurement report based on one or more SRSs transmitted via the one SRS resource set that is associated with the antenna selection usage.

At 725, the UE 115-c may transmit an antenna selection report indicating a set of selected antennas for one or more subsequent transmissions, where the set of selected antennas is based on the antenna selection information (e.g., the candidate set of antennas or the SRS measurement report). The antenna selection report may be transmitted via an uplink transmission resource that is based on the antenna selection information or other signaling received by the UE. The antenna selection report may be transmitted via an uplink transmission resource that is based on the antenna selection information or other signaling received by the UE.

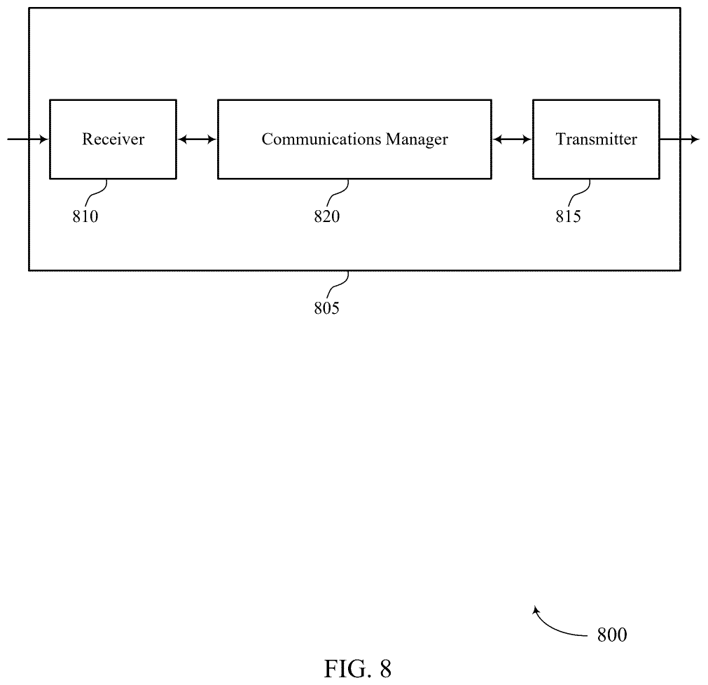

FIG. 8 shows a block diagram 800 of a device 805 that supports SRS resource reuse or collision handling and antenna selection reporting in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to SRS resource reuse or collision handling and antenna selection reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SRS resource reuse or collision handling and antenna selection reporting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of SRS resource reuse or collision handling and antenna selection reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a first SRS configuration that indicates a first SRS resource set associated with an antenna selection usage. The communications manager 820 is capable of, configured to, or operable to support a means for receiving a second SRS configuration that indicates a second SRS resource set associated with a second usage, where at least one SRS resource is included in both the first SRS resource set and the second SRS resource set. The communications manager 820 is capable of, configured to, or operable to support a means for transmitting a set of multiple SRSs that includes a first set of SRSs associated with the antenna selection usage and a second set of SRSs associated with the second usage, where at least one SRS of the set of multiple SRSs is transmitted via the at least one resource and is included in both the first set of SRSs and the second set of SRSs.

Additionally, or alternatively, the communications manager 820 may support wireless communications in accordance with examples as disclosed herein. For example, the communications manager 820 is capable of, configured to, or operable to support a means for receiving a first SRS configuration that indicates a first SRS resource set. The communications manager 820 is capable of, configured to, or operable to support a means for receiving a second SRS configuration that indicates a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage. The communications manager 820 is capable of, configured to, or operable to support a means for transmitting, based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource. The communications manager 820 is capable of, configured to, or operable to support a means for refraining, based at least in part on the overlap between the occasion of the first SRS resource and the occasion of the second SRS resource, from transmitting a second SRS via the occasion of the second SRS resource in accordance with the prioritization of the first SRS resource over the second SRS resource.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for efficient SRS utilization, handling collisions between SRS resource sets, or any combination thereof.

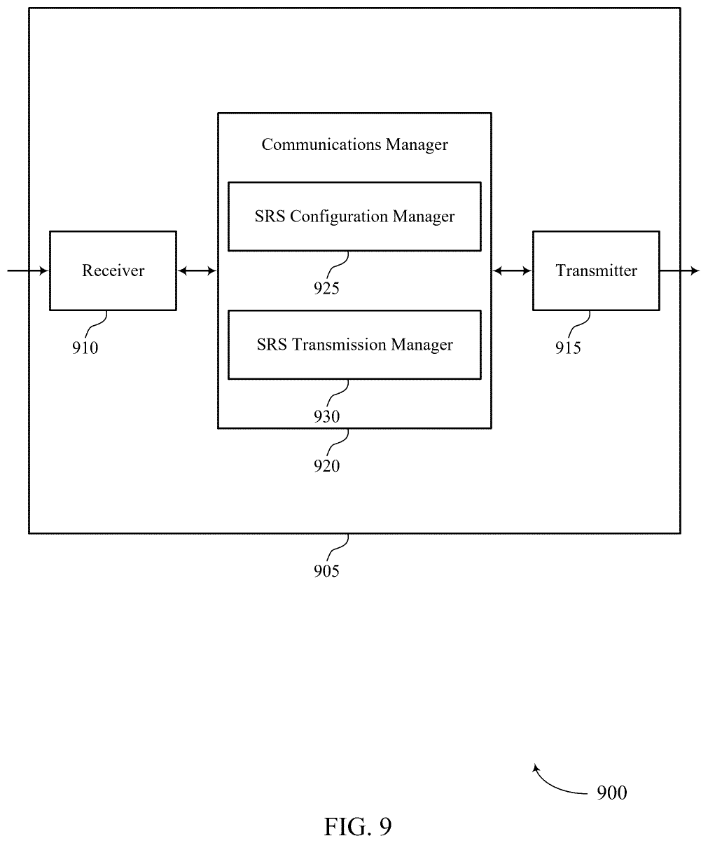

FIG. 9 shows a block diagram 900 of a device 905 that supports SRS resource reuse or collision handling and antenna selection reporting in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to SRS resource reuse or collision handling and antenna selection reporting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SRS resource reuse or collision handling and antenna selection reporting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of SRS resource reuse or collision handling and antenna selection reporting as described herein. For example, the communications manager 920 may include an SRS configuration manager 925 an SRS transmission manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The SRS configuration manager 925 is capable of, configured to, or operable to support a means for receiving a first SRS configuration that indicates a first SRS resource set associated with an antenna selection usage. The SRS configuration manager 925 is capable of, configured to, or operable to support a means for receiving a second SRS configuration that indicates a second SRS resource set associated with a second usage, where at least one SRS resource is included in both the first SRS resource set and the second SRS resource set. The SRS transmission manager 930 is capable of, configured to, or operable to support a means for transmitting a set of multiple SRSs that includes a first set of SRSs associated with the antenna selection usage and a second set of SRSs associated with the second usage, where at least one SRS of the set of multiple SRSs is transmitted via the at least one resource and is included in both the first set of SRSs and the second set of SRSs.

Additionally, or alternatively, the communications manager 920 may support wireless communications in accordance with examples as disclosed herein. The SRS configuration manager 925 is capable of, configured to, or operable to support a means for receiving a first SRS configuration that indicates a first SRS resource set. The SRS configuration manager 925 is capable of, configured to, or operable to support a means for receiving a second SRS configuration that indicates a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage. The SRS transmission manager 930 is capable of, configured to, or operable to support a means for transmitting, based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource. The SRS transmission manager 930 is capable of, configured to, or operable to support a means for refraining, based on the overlap between the occasion of the first SRS resource and the occasion of the second SRS resource, from transmitting a second SRS via the occasion of the second SRS resource in accordance with the prioritization of the first SRS resource over the second SRS resource.

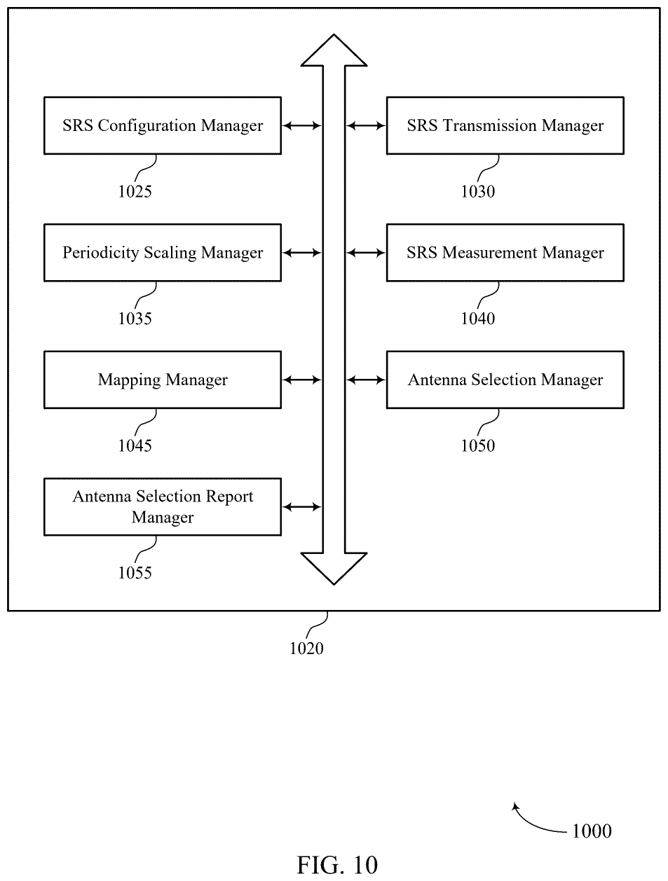

FIG. 10 shows a block diagram 1000 of a communications manager 1020 that supports SRS resource reuse or collision handling and antenna selection reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of SRS resource reuse or collision handling and antenna selection reporting as described herein. For example, the communications manager 1020 may include an SRS configuration manager 1025, an SRS transmission manager 1030, a periodicity scaling manager 1035, an SRS measurement manager 1040, a mapping manager 1045, an antenna selection manager 1050, an antenna selection report manager 1055, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The SRS configuration manager 1025 is capable of, configured to, or operable to support a means for receiving a first SRS configuration that indicates a first SRS resource set associated with an antenna selection usage. In some examples, the SRS configuration manager 1025 is capable of, configured to, or operable to support a means for receiving a second SRS configuration that indicates a second SRS resource set associated with a second usage, where at least one SRS resource is included in both the first SRS resource set and the second SRS resource set. The SRS transmission manager 1030 is capable of, configured to, or operable to support a means for transmitting a set of multiple SRSs that includes a first set of SRSs associated with the antenna selection usage and a second set of SRSs associated with the second usage, where at least one SRS of the set of multiple SRSs is transmitted via the at least one resource and is included in both the first set of SRSs and the second set of SRSs. In some examples, the second usage is a codebook usage.

In some examples, the periodicity scaling manager 1035 is capable of, configured to, or operable to support a means for receiving (e.g., as part of the first SRS configuration) an indication of a first periodicity scaling factor for the first SRS resource set, where the first SRS resource set has a first periodicity that is based on a base periodicity and the first periodicity scaling factor. In some examples, the periodicity scaling manager 1035 is capable of, configured to, or operable to support a means for receiving (e.g., as part of the second SRS configuration) an indication of a second periodicity scaling factor for the second SRS resource set that is different than the first periodicity scaling factor, where the second SRS resource set has a second periodicity that is different than the first periodicity and is based on the base periodicity and the second periodicity scaling factor.

In some examples, the SRS measurement manager 1040 is capable of, configured to, or operable to support a means for receiving an indication of one or more SRS measurements, one or more candidate antenna selections, or any combination thereof, where the one or more SRS measurements, the one or more candidate antenna selections, or any combination thereof are based on a most recent SRS associated with the antenna selection usage that is transmitted at least a threshold duration prior to receipt of the indication of the one or more SRS measurements.

In some examples, the one or more SRS measurements, the one or more candidate antenna selections, or any combination thereof are based on a time domain filtering that is reset based on a prior indication of one or more prior SRS measurements, one or more candidate antenna selections, or any combination thereof.

In some examples, the mapping manager 1045 is capable of, configured to, or operable to support a means for transmitting an indication of an update to a mapping between at least one antenna port associated with the antenna selection usage and at least one SRS resource of the second SRS resource set, where transmitting the set of multiple SRSs is in accordance with the updated mapping.

In some examples, the antenna selection manager 1050 is capable of, configured to, or operable to support a means for receiving an indication of a candidate set of antennas or an SRS measurement report based on the first set of SRSs that is associated with the antenna selection usage. In some examples, the antenna selection report manager 1055 is capable of, configured to, or operable to support a means for transmitting an antenna selection report indicating a set of selected antennas for one or more subsequent transmissions, where the set of selected antennas is based on the candidate set of antennas or the SRS measurement report.

In some examples, to support transmitting the antenna selection report, the antenna selection report manager 1055 is capable of, configured to, or operable to support a means for transmitting the antenna selection report via an uplink transmission resource that is based on the indication of the candidate set of antennas, the SRS measurement report, or other signaling received by the UE.

Additionally, or alternatively, the communications manager 1020 may support wireless communications in accordance with examples as disclosed herein. In some examples, the SRS configuration manager 1025 is capable of, configured to, or operable to support a means for receiving a first SRS configuration that indicates a first SRS resource set. In some examples, the SRS configuration manager 1025 is capable of, configured to, or operable to support a means for receiving a second SRS configuration that indicates a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage. In some examples, the SRS transmission manager 1030 is capable of, configured to, or operable to support a means for transmitting, based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource. In some examples, the SRS transmission manager 1030 is capable of, configured to, or operable to support a means for refraining, based on the overlap between the occasion of the first SRS resource and the occasion of the second SRS resource, from transmitting a second SRS via the occasion of the second SRS resource in accordance with the prioritization of the first SRS resource over the second SRS resource. In some examples, the second usage is a codebook usage.

In some examples, the prioritization of the first SRS resource over the second SRS resource is based on a first index value associated with the first SRS resource being lower than a second index value associated with the second SRS resource.

In some examples, the prioritization of the first SRS resource over the second SRS resource is based on a first periodicity associated with the first SRS resource corresponding to a longer period than a second periodicity associated with the second SRS resource.

In some examples, the prioritization of the first SRS resource over the second SRS resource is based on the antenna selection usage associated with the first SRS resource having a higher priority than the second usage associated with the second SRS resource.

In some examples, the antenna selection manager 1050 is capable of, configured to, or operable to support a means for receiving an indication of a candidate set of antennas or an SRS measurement report based on one or more SRSs transmitted via the one SRS resource set that is associated with the antenna selection usage. In some examples, the antenna selection report manager 1055 is capable of, configured to, or operable to support a means for transmitting an antenna selection report indicating a set of selected antennas for one or more subsequent transmissions, where the set of selected antennas is based on the candidate set of antennas or the SRS measurement report.

In some examples, to support transmitting the antenna selection report, the antenna selection report manager 1055 is capable of, configured to, or operable to support a means for transmitting the antenna selection report via an uplink transmission resource that is based on the indication of the candidate set of antennas, the SRS measurement report, or other signaling received by the UE.

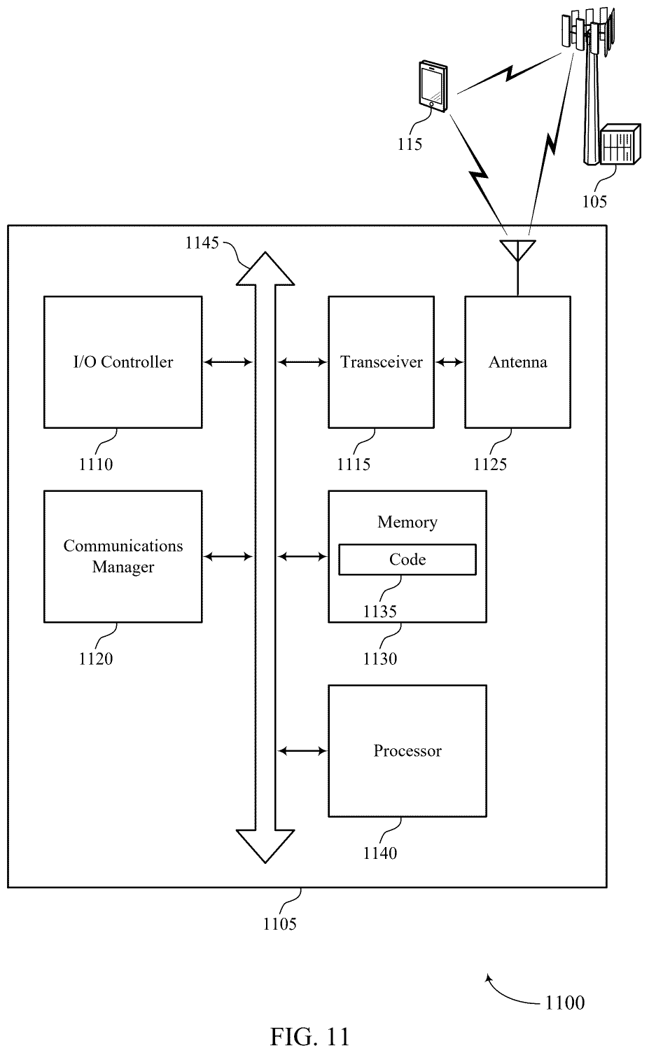

FIG. 11 shows a diagram of a system 1100 including a device 1105 that supports SRS resource reuse or collision handling and antenna selection reporting in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting SRS resource reuse or collision handling and antenna selection reporting). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving a first SRS configuration that indicates a first SRS resource set associated with an antenna selection usage. The communications manager 1120 is capable of, configured to, or operable to support a means for receiving a second SRS configuration that indicates a second SRS resource set associated with a second usage, where at least one SRS resource is included in both the first SRS resource set and the second SRS resource set. The communications manager 1120 is capable of, configured to, or operable to support a means for transmitting a set of multiple SRSs that includes a first set of SRSs associated with the antenna selection usage and a second set of SRSs associated with the second usage, where at least one SRS of the set of multiple SRSs is transmitted via the at least one resource and is included in both the first set of SRSs and the second set of SRSs.

Additionally, or alternatively, the communications manager 1120 may support wireless communications in accordance with examples as disclosed herein. For example, the communications manager 1120 is capable of, configured to, or operable to support a means for receiving a first SRS configuration that indicates a first SRS resource set. The communications manager 1120 is capable of, configured to, or operable to support a means for receiving a second SRS configuration that indicates a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage. The communications manager 1120 is capable of, configured to, or operable to support a means for transmitting, based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource. The communications manager 1120 is capable of, configured to, or operable to support a means for refraining, based at least in part on the overlap between the occasion of the first SRS resource and the occasion of the second SRS resource, from transmitting a second SRS via the occasion of the second SRS resource in accordance with the prioritization of the first SRS resource over the second SRS resource.

By including or configuring the communications manager 1120 in accordance with examples as described herein, the device 1105 may support techniques for efficient SRS utilization, handling collisions between SRS resource sets, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. For example, the communications manager 1020 may be configured to receive or transmit messages or other signaling as described herein via the transceiver 1115. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of SRS resource reuse or collision handling and antenna selection reporting as described herein, or the at least one processor 1140 and the at least one memory 1130 may be otherwise configured to, individually or collectively, perform or support such operations.

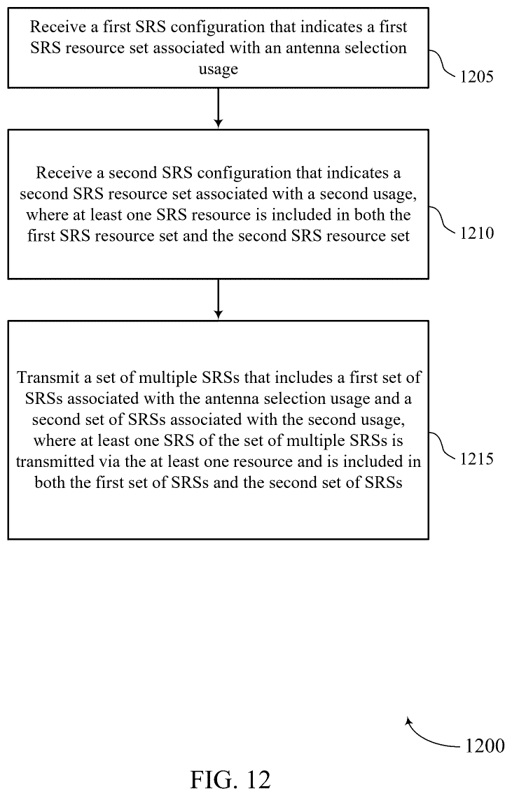

FIG. 12 shows a flowchart illustrating a method 1200 that supports SRS resource reuse or collision handling and antenna selection reporting in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a first SRS configuration that indicates a first SRS resource set associated with an antenna selection usage. The operations of 1205 may be performed in accordance with examples as disclosed herein. In some examples, aspects of the operations of 1205 may be performed by an SRS configuration manager 1025 as described with reference to FIG. 10. Additionally, or alternatively, means for performing 1205 may, but not necessarily, include, for example, antenna 1125, transceiver 1115, communications manager 1120, memory 1130 (including code 1135), processor 1140 and/or bus 1145.

At 1210, the method may include receiving a second SRS configuration that indicates a second SRS resource set associated with a second usage, where at least one SRS resource is included in both the first SRS resource set and the second SRS resource set. The operations of 1210 may be performed in accordance with examples as disclosed herein. In some examples, aspects of the operations of 1210 may be performed by an SRS configuration manager 1025 as described with reference to FIG. 10. Additionally, or alternatively, means for performing 1210 may, but not necessarily, include, for example, antenna 1125, transceiver 1115, communications manager 1120, memory 1130 (including code 1135), processor 1140 and/or bus 1145.

At 1215, the method may include transmitting a set of multiple SRSs that includes a first set of SRSs associated with the antenna selection usage and a second set of SRSs associated with the second usage, where at least one SRS of the set of multiple SRSs is transmitted via the at least one resource and is included in both the first set of SRSs and the second set of SRSs. The operations of 1215 may be performed in accordance with examples as disclosed herein. In some examples, aspects of the operations of 1215 may be performed by an SRS transmission manager 1030 as described with reference to FIG. 10. Additionally, or alternatively, means for performing 1215 may, but not necessarily, include, for example, antenna 1125, transceiver 1115, communications manager 1120, memory 1130 (including code 1135), processor 1140 and/or bus 1145.

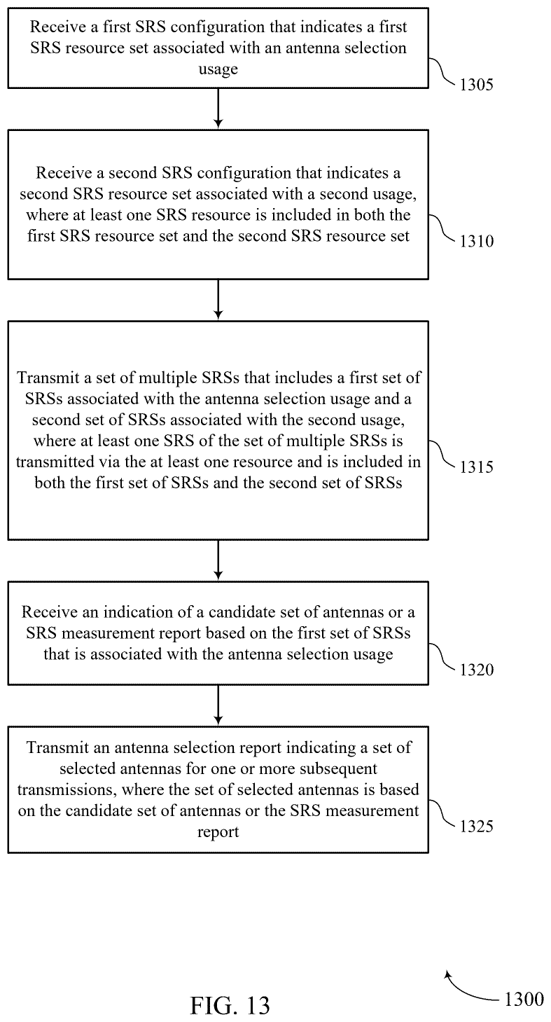

FIG. 13 shows a flowchart illustrating a method 1300 that supports SRS resource reuse or collision handling and antenna selection reporting in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving a first SRS configuration that indicates a first SRS resource set associated with an antenna selection usage. The operations of 1305 may be performed in accordance with examples as disclosed herein. In some examples, aspects of the operations of 1305 may be performed by an SRS configuration manager 1025 as described with reference to FIG. 10. Additionally, or alternatively, means for performing 1305 may, but not necessarily, include, for example, antenna 1125, transceiver 1115, communications manager 1120, memory 1130 (including code 1135), processor 1140 and/or bus 1145.

At 1310, the method may include receiving a second SRS configuration that indicates a second SRS resource set associated with a second usage, where at least one SRS resource is included in both the first SRS resource set and the second SRS resource set. The operations of 1310 may be performed in accordance with examples as disclosed herein. In some examples, aspects of the operations of 1310 may be performed by an SRS configuration manager 1025 as described with reference to FIG. 10. Additionally, or alternatively, means for performing 1310 may, but not necessarily, include, for example, antenna 1125, transceiver 1115, communications manager 1120, memory 1130 (including code 1135), processor 1140 and/or bus 1145.

At 1315, the method may include transmitting a set of multiple SRSs that includes a first set of SRSs associated with the antenna selection usage and a second set of SRSs associated with the second usage, where at least one SRS of the set of multiple SRSs is transmitted via the at least one resource and is included in both the first set of SRSs and the second set of SRSs. The operations of 1315 may be performed in accordance with examples as disclosed herein. In some examples, aspects of the operations of 1315 may be performed by an SRS transmission manager 1030 as described with reference to FIG. 10. Additionally, or alternatively, means for performing 1315 may, but not necessarily, include, for example, antenna 1125, transceiver 1115, communications manager 1120, memory 1130 (including code 1135), processor 1140 and/or bus 1145.

At 1320, the method may include receiving an indication of a candidate set of antennas or an SRS measurement report based on the first set of SRSs that is associated with the antenna selection usage. The operations of 1320 may be performed in accordance with examples as disclosed herein. In some examples, aspects of the operations of 1320 may be performed by an antenna selection manager 1050 as described with reference to FIG. 10. Additionally, or alternatively, means for performing 1320 may, but not necessarily, include, for example, antenna 1125, transceiver 1115, communications manager 1120, memory 1130 (including code 1135), processor 1140 and/or bus 1145.

At 1325, the method may include transmitting an antenna selection report indicating a set of selected antennas for one or more subsequent transmissions, where the set of selected antennas is based on the candidate set of antennas or the SRS measurement report. The operations of 1325 may be performed in accordance with examples as disclosed herein. In some examples, aspects of the operations of 1325 may be performed by an antenna selection report manager 1055 as described with reference to FIG. 10. Additionally, or alternatively, means for performing 1325 may, but not necessarily, include, for example, antenna 1125, transceiver 1115, communications manager 1120, memory 1130 (including code 1135), processor 1140 and/or bus 1145.

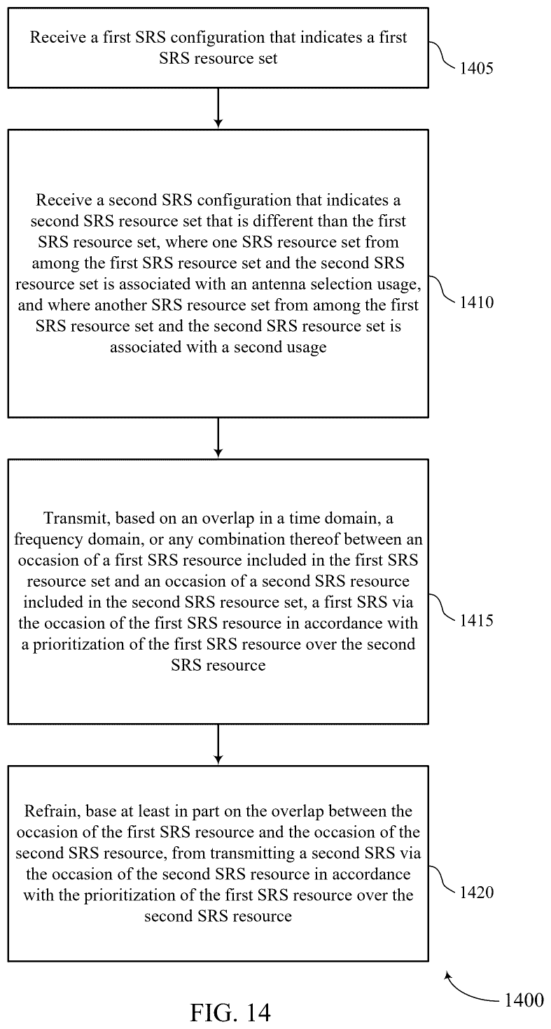

FIG. 14 shows a flowchart illustrating a method 1400 that supports SRS resource reuse or collision handling and antenna selection reporting in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving a first SRS configuration that indicates a first SRS resource set. The operations of 1405 may be performed in accordance with examples as disclosed herein. In some examples, aspects of the operations of 1405 may be performed by an SRS configuration manager 1025 as described with reference to FIG. 10. Additionally, or alternatively, means for performing 1405 may, but not necessarily, include, for example, antenna 1125, transceiver 1115, communications manager 1120, memory 1130 (including code 1135), processor 1140 and/or bus 1145.

At 1410, the method may include receiving a second SRS configuration that indicates a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage. The operations of 1410 may be performed in accordance with examples as disclosed herein. In some examples, aspects of the operations of 1410 may be performed by an SRS configuration manager 1025 as described with reference to FIG. 10. Additionally, or alternatively, means for performing 1410 may, but not necessarily, include, for example, antenna 1125, transceiver 1115, communications manager 1120, memory 1130 (including code 1135), processor 1140 and/or bus 1145.

At 1415, the method may include transmitting, based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource. The operations of 1415 may be performed in accordance with examples as disclosed herein. In some examples, aspects of the operations of 1415 may be performed by an SRS transmission manager 1030 as described with reference to FIG. 10. Additionally, or alternatively, means for performing 1415 may, but not necessarily, include, for example, antenna 1125, transceiver 1115, communications manager 1120, memory 1130 (including code 1135), processor 1140 and/or bus 1145.

At 1420, the method may include refraining, based on the overlap between the occasion of the first SRS resource and the occasion of the second SRS resource, from transmitting a second SRS via the occasion of the second SRS resource in accordance with the prioritization of the first SRS resource over the second SRS resource. The operations of 1420 may be performed in accordance with examples as disclosed herein. In some examples, aspects of the operations of 1420 may be performed by an SRS transmission manager 1030 as described with reference to FIG. 10. Additionally, or alternatively, means for performing 1420 may, but not necessarily, include, for example, antenna 1125, transceiver 1115, communications manager 1120, memory 1130 (including code 1135), processor 1140 and/or bus 1145.

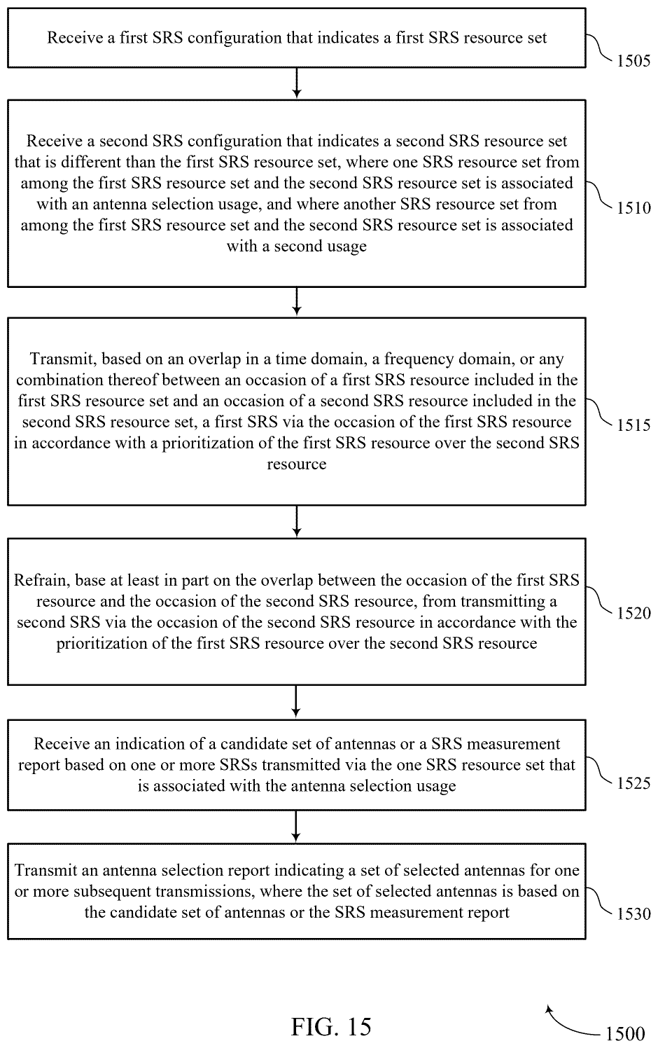

FIG. 15 shows a flowchart illustrating a method 1500 that supports SRS resource reuse or collision handling and antenna selection reporting in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving a first SRS configuration that indicates a first SRS resource set. The operations of 1505 may be performed in accordance with examples as disclosed herein. In some examples, aspects of the operations of 1505 may be performed by an SRS configuration manager 1025 as described with reference to FIG. 10. Additionally, or alternatively, means for performing 1505 may, but not necessarily, include, for example, antenna 1125, transceiver 1115, communications manager 1120, memory 1130 (including code 1135), processor 1140 and/or bus 1145.

At 1510, the method may include receiving a second SRS configuration that indicates a second SRS resource set that is different than the first SRS resource set, where one SRS resource set from among the first SRS resource set and the second SRS resource set is associated with an antenna selection usage, and where another SRS resource set from among the first SRS resource set and the second SRS resource set is associated with a second usage. The operations of 1510 may be performed in accordance with examples as disclosed herein. In some examples, aspects of the operations of 1510 may be performed by an SRS configuration manager 1025 as described with reference to FIG. 10. Additionally, or alternatively, means for performing 1510 may, but not necessarily, include, for example, antenna 1125, transceiver 1115, communications manager 1120, memory 1130 (including code 1135), processor 1140 and/or bus 1145.

At 1515, the method may include transmitting, based on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource. The operations of 1515 may be performed in accordance with examples as disclosed herein. In some examples, aspects of the operations of 1515 may be performed by an SRS transmission manager 1030 as described with reference to FIG. 10. Additionally, or alternatively, means for performing 1515 may, but not necessarily, include, for example, antenna 1125, transceiver 1115, communications manager 1120, memory 1130 (including code 1135), processor 1140 and/or bus 1145.

At 1520, the method may include refraining, based on the overlap between the occasion of the first SRS resource and the occasion of the second SRS resource, from transmitting a second SRS via the occasion of the second SRS resource in accordance with the prioritization of the first SRS resource over the second SRS resource. The operations of 1520 may be performed in accordance with examples as disclosed herein. In some examples, aspects of the operations of 1520 may be performed by an SRS transmission manager 1030 as described with reference to FIG. 10. Additionally, or alternatively, means for performing 1520 may, but not necessarily, include, for example, antenna 1125, transceiver 1115, communications manager 1120, memory 1130 (including code 1135), processor 1140 and/or bus 1145.

At 1525, the method may include receiving an indication of a candidate set of antennas or an SRS measurement report based on the first set of SRSs that is associated with the antenna selection usage. The operations of 1525 may be performed in accordance with examples as disclosed herein. In some examples, aspects of the operations of 1525 may be performed by an antenna selection manager 1050 as described with reference to FIG. 10. Additionally, or alternatively, means for performing 1525 may, but not necessarily, include, for example, antenna 1125, transceiver 1115, communications manager 1120, memory 1130 (including code 1135), processor 1140 and/or bus 1145.

At 1530, the method may include transmitting an antenna selection report indicating a set of selected antennas for one or more subsequent transmissions, where the set of selected antennas is based on the candidate set of antennas or the SRS measurement report. The operations of 1530 may be performed in accordance with examples as disclosed herein. In some examples, aspects of the operations of 1530 may be performed by an antenna selection report manager 1055 as described with reference to FIG. 10. Additionally, or alternatively, means for performing 1530 may, but not necessarily, include, for example, antenna 1125, transceiver 1115, communications manager 1120, memory 1130 (including code 1135), processor 1140 and/or bus 1145. The following provides an overview of aspects of the present disclosure:
Aspect 1: A method for wireless communications at a UE, comprising: receiving, at the UE, a first SRS configuration that indicates a first SRS resource set associated with an antenna selection usage, receiving, at the UE, a second SRS configuration that indicates a second SRS resource set associated with a second usage, wherein at least one SRS resource is included in both the first SRS resource set and the second SRS resource set, and transmitting, by the UE, a plurality of SRSs that comprises a first set of SRSs associated with the antenna selection usage and a second set of SRSs associated with the second usage, wherein at least one SRS of the plurality of SRSs is transmitted via the at least one resource and is included in both the first set of SRSs and the second set of SRSs.
Aspect 2: The method of aspect 1, further comprising: receiving, at the UE, an indication of a first periodicity scaling factor for the first SRS resource set, wherein the first SRS resource set has a first periodicity that is based at least in part on a base periodicity and the first periodicity scaling factor, and receiving, at the UE, an indication of a second periodicity scaling factor for the second SRS resource set that is different than the first periodicity scaling factor, wherein the second SRS resource set has a second periodicity that is different than the first periodicity and is based at least in part on the base periodicity and the second periodicity scaling factor.
Aspect 3: The method of any of aspects 1 through 2, further comprising: receiving, at the UE, an indication of one or more SRS measurements, one or more candidate antenna selections, or any combination thereof, wherein the one or more SRS measurements, the one or more candidate antenna selections, or any combination thereof are based at least in part on a most recent SRS associated with the antenna selection usage that is transmitted at least a threshold duration prior to receipt of the indication of the one or more SRS measurements.
Aspect 4: The method of any of aspects 1 through 3, wherein: the one or more SRS measurements, the one or more candidate antenna selections, or any combination thereof are based at least in part on a time domain filtering that is reset based at least in part on a prior indication of one or more prior SRS measurements, one or more candidate antenna selections, or any combination thereof.
Aspect 5: The method of any of aspects 1 through 4, further comprising: transmitting, by the UE, an indication of an update to a mapping between at least one antenna port associated with the antenna selection usage and at least one SRS resource of the second SRS resource set, wherein transmitting the plurality of SRSs is in accordance with the updated mapping.
Aspect 6: The method of any of aspects 1 through 5, further comprising: receiving, at the UE, an indication of a candidate set of antennas or a SRS measurement report based at least in part on the first set of SRSs that is associated with the antenna selection usage, and transmitting, by the UE, an antenna selection report indicating a set of selected antennas for one or more subsequent transmissions, wherein the set of selected antennas is based at least in part on the candidate set of antennas or the SRS measurement report.
Aspect 7: The method of any of aspects 1 through 6, wherein transmitting the antenna selection report comprises: transmitting, by the UE, the antenna selection report via an uplink transmission resource that is based at least in part on the indication of the candidate set of antennas, the SRS measurement report, or other signaling received by the UE.
Aspect 8: The method of any of aspects 1 through 7, wherein the second usage is a codebook usage.
Aspect 9: A method for wireless communications at a UE, comprising: receiving, at the UE, a first SRS configuration indicating a first SRS resource set, receiving, at the UE, a second SRS configuration indicating a second SRS resource set that is different than the first SRS resource set, wherein one SRS resource set from among the first SRS resource set and the second SRS resource set is associated with an antenna selection usage, and wherein another SRS resource set from among the first SRS resource set and the second SRS resource set is associated with a second usage, transmitting, by the UE and based at least in part on an overlap in a time domain, a frequency domain, or any combination thereof between an occasion of a first SRS resource included in the first SRS resource set and an occasion of a second SRS resource included in the second SRS resource set, a first SRS via the occasion of the first SRS resource in accordance with a prioritization of the first SRS resource over the second SRS resource, and refraining, by the UE and based at least in part on the overlap between the occasion of the first SRS resource and the occasion of the second SRS resource, from transmitting a second SRS via the occasion of the second SRS resource in accordance with the prioritization of the first SRS resource over the second SRS resource.
Aspect 10: The method of aspect 9, wherein the prioritization of the first SRS resource over the second SRS resource is based at least in part on a first index value associated with the first SRS resource being lower than a second index value associated with the second SRS resource.
Aspect 11: The method of any of aspects 9 through 10, wherein the prioritization of the first SRS resource over the second SRS resource is based at least in part on a first periodicity associated with the first SRS resource corresponding to a longer period than a second periodicity associated with the second SRS resource.
Aspect 12: The method of any of aspects 9 through 11, wherein the prioritization of the first SRS resource over the second SRS resource is based at least in part on the antenna selection usage associated with the first SRS resource having a higher priority than the second usage associated with the second SRS resource.
Aspect 13: The method of any of aspects 9 through 12, further comprising: receiving, at the UE via the transceiver, an indication of a candidate set of antennas or a SRS measurement report based at least in part on one or more SRSs transmitted via the one SRS resource set that is associated with the antenna selection usage, and transmitting, by the UE via the transceiver, an antenna selection report indicating a set of selected antennas for one or more subsequent transmissions, wherein the set of selected antennas is based at least in part on the candidate set of antennas or the SRS measurement report.
Aspect 14: The method of any of aspects 9 through 13, wherein transmitting the antenna selection report comprises: transmitting, by the UE via the transceiver, the antenna selection report via an uplink transmission resource that is based at least in part on the indication of the candidate set of antennas, the SRS measurement report, or other signaling received by the UE.
Aspect 15: The method of any of aspects 9 through 14, wherein the second usage is a codebook usage.
Aspect 16: A UE for wireless communications, comprising one or more memories storing processor-executable code, a transceiver, and one or more processors coupled with the one or more memories, the one or more processors individually or collectively operable to execute the code to cause the UE to perform a method of any of aspects 1 through 15.
Aspect 17: A UE for wireless communications, comprising at least one means for performing a method of any of aspects 1 through 15.
Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and transceiver, the one or more processors individually or collectively operable to execute the code to cause the UE to:
receive, at the UE via the transceiver, a first sounding reference signal configuration that indicates a first sounding reference signal resource set associated with an antenna selection usage;
receive, at the UE via the transceiver, a second sounding reference signal configuration that indicates a second sounding reference signal resource set associated with a second usage, wherein at least one sounding reference signal resource is included in both the first sounding reference signal resource set and the second sounding reference signal resource set; and
transmit, by the UE via the transceiver, a plurality of sounding reference signals that comprises a first set of sounding reference signals associated with the antenna selection usage and a second set of sounding reference signals associated with the second usage, wherein at least one sounding reference signal of the plurality of sounding reference signals is transmitted via the at least one resource and is included in both the first set of sounding reference signals and the second set of sounding reference signals.

2. The UE of claim 1, wherein the one or more processors are individually or collectively further operable to execute the code to cause the UE to:
receive, at the UE via the transceiver, an indication of a first periodicity scaling factor for the first sounding reference signal resource set, wherein the first sounding reference signal resource set has a first periodicity that is based at least in part on a base periodicity and the first periodicity scaling factor; and
receive, at the UE via the transceiver, an indication of a second periodicity scaling factor for the second sounding reference signal resource set that is different than the first periodicity scaling factor, wherein the second sounding reference signal resource set has a second periodicity that is different than the first periodicity and is based at least in part on the base periodicity and the second periodicity scaling factor.

3. The UE of claim 1, wherein the one or more processors are individually or collectively further operable to execute the code to cause the UE to:
receive, at the UE via the transceiver, an indication of one or more sounding reference signal measurements, one or more candidate antenna selections, or any combination thereof, wherein the one or more sounding reference signal measurements, the one or more candidate antenna selections, or any combination thereof are based at least in part on a most recent sounding reference signal associated with the antenna selection usage that is transmitted at least a threshold duration prior to receipt of the indication of the one or more sounding reference signal measurements.

4. The UE of claim 3, wherein the one or more sounding reference signal measurements, the one or more candidate antenna selections, or any combination thereof are based at least in part on a time domain filtering that is reset based at least in part on a prior indication of one or more prior sounding reference signal measurements, one or more candidate antenna selections, or any combination thereof.

5. The UE of claim 1, wherein the one or more processors are individually or collectively further operable to execute the code to cause the UE to:
transmit, by the UE via the transceiver, an indication of an update to a mapping between at least one antenna port associated with the antenna selection usage and at least one sounding reference signal resource of the second sounding reference signal resource set, wherein transmitting the plurality of sounding reference signals is in accordance with the updated mapping.

6. The UE of claim 1, wherein the one or more processors are individually or collectively further operable to execute the code to cause the UE to:
receive, at the UE via the transceiver, an indication of a candidate set of antennas or a sounding reference signal measurement report based at least in part on the first set of sounding reference signals that is associated with the antenna selection usage; and
transmit, by the UE via the transceiver, an antenna selection report indicating a set of selected antennas for one or more subsequent transmissions, wherein the set of selected antennas is based at least in part on the candidate set of antennas or the sounding reference signal measurement report.

7. The UE of claim 6, wherein, to transmit the antenna selection report, the one or more processors are individually or collectively operable to execute the code to cause the UE to:
transmit, by the UE via the transceiver, the antenna selection report via an uplink transmission resource that is based at least in part on the indication of the candidate set of antennas, the sounding reference signal measurement report, or other signaling received by the UE.

8. The UE of claim 1, wherein the second usage is a codebook usage.

9. A user equipment (UE), comprising:
one or more memories storing processor-executable code;
a transceiver; and
one or more processors coupled with the one or more memories and transceiver, the one or more processors individually or collectively operable to execute the code to cause the UE to:
receive, at the UE via the transceiver, a first sounding reference signal configuration indicating a first sounding reference signal resource set;
receive, at the UE via the transceiver, a second sounding reference signal configuration indicating a second sounding reference signal resource set that is different than the first sounding reference signal resource set, wherein one sounding reference signal resource set from among the first sounding reference signal resource set and the second sounding reference signal resource set is associated with an antenna selection usage, and wherein another sounding reference signal resource set from among the first sounding reference signal resource set and the second sounding reference signal resource set is associated with a second usage;
transmit, by the UE via the transceiver and based at least in part on an overlap in a time domain, a frequency domain, or any combination thereof between an occasion of a first sounding reference signal resource included in the first sounding reference signal resource set and an occasion of a second sounding reference signal resource included in the second sounding reference signal resource set, a first sounding reference signal via the occasion of the first sounding reference signal resource in accordance with a prioritization of the first sounding reference signal resource over the second sounding reference signal resource; and
refrain, by the UE and based at least in part on the overlap between the occasion of the first sounding reference signal resource and the occasion of the second sounding reference signal resource, from transmitting a second sounding reference signal via the occasion of the second sounding reference signal resource in accordance with the prioritization of the first sounding reference signal resource over the second sounding reference signal resource.

10. The UE of claim 9, wherein the prioritization of the first sounding reference signal resource over the second sounding reference signal resource is based at least in part on a first index value associated with the first sounding reference signal resource being lower than a second index value associated with the second sounding reference signal resource.

11. The UE of claim 9, wherein the prioritization of the first sounding reference signal resource over the second sounding reference signal resource is based at least in part on a first periodicity associated with the first sounding reference signal resource corresponding to a longer period than a second periodicity associated with the second sounding reference signal resource.

12. The UE of claim 9, wherein the prioritization of the first sounding reference signal resource over the second sounding reference signal resource is based at least in part on the antenna selection usage associated with the first sounding reference signal resource having a higher priority than the second usage associated with the second sounding reference signal resource.

13. The UE of claim 9, wherein the one or more processors are individually or collectively further operable to execute the code to cause the UE to:
receive, at the UE via the transceiver, an indication of a candidate set of antennas or a sounding reference signal measurement report based at least in part on one or more sounding reference signals transmitted via the one sounding reference signal resource set that is associated with the antenna selection usage; and
transmit, by the UE via the transceiver, an antenna selection report indicating a set of selected antennas for one or more subsequent transmissions, wherein the set of selected antennas is based at least in part on the candidate set of antennas or the sounding reference signal measurement report.

14. The UE of claim 13, wherein, to transmit the antenna selection report, the one or more processors are individually or collectively further operable to execute the code to cause the UE to:
transmit, by the UE via the transceiver, the antenna selection report via an uplink transmission resource that is based at least in part on the indication of the candidate set of antennas, the sounding reference signal measurement report, or other signaling received by the UE.

15. The UE of claim 9, wherein the second usage is a codebook usage.

16. A method for wireless communications, at user equipment (UE) comprising:
receiving a first sounding reference signal configuration indicating a first sounding reference signal resource set associated with an antenna selection usage;
receiving a second sounding reference signal configuration indicating a second sounding reference signal resource set associated with a second usage, wherein at least one sounding reference signal resource is included in both the first sounding reference signal resource set and the second sounding reference signal resource set; and
transmitting a plurality of sounding reference signals that comprises a first set of sounding reference signals associated with the antenna selection usage and a second set of sounding reference signals associated with the second usage, wherein at least one sounding reference signal of the plurality of sounding reference signals is transmitted via the at least one resource and is included in both the first set of sounding reference signals and the second set of sounding reference signals.

17. The method of claim 16, further comprising:
receiving an indication of a first periodicity scaling factor for the first sounding reference signal resource set, wherein the first sounding reference signal resource set has a first periodicity that is based at least in part on a base periodicity and the first periodicity scaling factor; and
receiving an indication of a second periodicity scaling factor for the second sounding reference signal resource set that is different than the first periodicity scaling factor, wherein the second sounding reference signal resource set has a second periodicity that is different than the first periodicity and is based at least in part on the base periodicity and the second periodicity scaling factor.

18. The method of claim 16, further comprising:
receiving an indication of one or more sounding reference signal measurements, one or more candidate antenna selections, or any combination thereof, wherein the one or more sounding reference signal measurements, the one or more candidate antenna selections, or any combination thereof are based at least in part on a most recent sounding reference signal associated with the antenna selection usage that is transmitted at least a threshold duration prior to receipt of the indication of the one or more sounding reference signal measurements.

19. The method of claim 16, further comprising:
transmitting an indication of an update to a mapping between at least one antenna port associated with the antenna selection usage and at least one sounding reference signal resource of the second sounding reference signal resource set, wherein transmitting the plurality of sounding reference signals is in accordance with the updated mapping.

20. The method of claim 16, further comprising:
receiving an indication of a candidate set of antennas or a sounding reference signal measurement report based at least in part on the first set of sounding reference signals that is associated with the antenna selection usage; and
transmitting an antenna selection report indicating a set of selected antennas for one or more subsequent transmissions, wherein the set of selected antennas is based at least in part on the candidate set of antennas or the sounding reference signal measurement report.
